(19) United States
(12) Patent Application Publication
(10) Pub. No.: US 2024/0322930 A1
(43) Pub. Date: Sep. 26, 2024

(54) DEVICES AND METHODS FOR WIRELESS COMMUNICATION USING ADVANCED DEMODULATION REFERENCE SIGNALS

(71) Applicant: Samsung Electronics Co., Ltd., Suwon-si (KR)

(72) Inventors: Alexei Vladimirovich DAVYDOV, Saratov (RU); Dmitry Sergeyevich DIKAREV, Saratov (RU); Gregory Aleksandrovich ERMOLAEV, Saratov (RU); Gregory Vladimirovich MOROZOV, Saratov (RU)

(21) Appl. No.: 18/615,343

(22) Filed: Mar. 25, 2024

(30) Foreign Application Priority Data
Mar. 24, 2023 (RU) 2023107128

(51) Int. Cl. H04J 13/00; H04L 5/00; H04W 72/0446; H04W 72/0453; H04W 72/20

(52) U.S. Cl. CPC H04J 13/004; H04L 5/0051; H04W 72/0446; H04W 72/0453; H04W 72/20

(57) ABSTRACT

The disclosure relates to wireless communications, and, in particular, to devices and methods for wireless communication using advanced demodulation reference signals (DMRSs). A method by a user equipment (UE) in a wireless communication system is provided. The method includes receiving, by the UE from a base station, at least one configuration information associated with a demodulation reference signal (DMRS), identifying, by the UE, at least one of a code division multiplexing (CDM) group, a frequency domain (FD) orthogonal cover code (OCC), and a time domain (TD) OCC for the DMRS based on the at least one configuration information; and receiving, by the UE from the base station, the DMRS based on the at least one of the CDM group, the FD OCC, and the TD OCC, wherein a number of CDM groups is 4, wherein the FD OCC includes at least one of (+1,+1,+1,+1), (+1,−j,+1,+j), (+1,−1,+1,−1), and (+1,+j,−1,−1), and wherein the TD OCC includes at least one of (+1,+1,+1,+1), (+1,−j,+1,+j), (+1,−1,+1,−1), and (+1,+j,−1,−1).

### CROSS-REFERENCE TO RELATED APPLICATION(S)

This application is based on and claims priority under 35 U.S.C. § 119(a) of a Russian patent application number 2023107128, filed on Mar. 24, 2023, in the Russian Intellectual Property Office, the disclosure of which is incorporated by reference herein in its entirety.

### BACKGROUND

### 1. Field

The disclosure relates to wireless communications. More particularly, the disclosure relates to devices and methods for wireless communication using advanced demodulation reference signals (DMRSs).

### 2. Description of Related Art

Nowadays more and more active deployment of 5^{th} Generation (5G) New Radio (NR) networks takes place whose advantages and capabilities are broadly known.

In a 5G NR system, base stations (Transmission-Reception Points, (TRPs)) use complex antenna arrays comprising plural transceiving antenna elements that enable to efficiently use the Multiple Input-Multiple Output (MIMO) technology when a number of spatial MIMO layers (or streams), which are to be transmitted in parallel, are generated to transmit data (e.g., the physical downlink data shared channel (PDSCH)).

A digital signal is transmitted or received by one or more digital ports coupled to antenna elements of a base station via a radio frequency unit which performs the function of forward and inverse conversion of the digital signal into an analog one. In particular, for the frequency range of 3.5 GHz up to 64 digital antenna ports may be employed which enable to use, in base stations, various precoding schemes. For instance, the spatial multiplexing (SM) technology enables to reuse the same time-frequency resources to transmit plural signals (MIMO layers) to one or more user devices (user equipments, (UEs)), while the adaptive beamforming technology enables to dynamically steer power of a transmitted signal into one or more predefined directions. Usage of advanced modulation techniques, such as orthogonal frequency-division multiplexing (OFDM), provides efficient broadband signal transmission. OFDM provides orthogonality of signals which are simultaneously transmitted on different subcarriers (i.e., orthogonality in the frequency domain). Spatial MIMO layers are in general not orthogonal, and signals transmitted in different MIMO layers cause interference at a receiver side. As a rule, various adaptive beamforming techniques are employed in a receiver and in a transmitter to reduce the interference.

Furthermore, the transmitted MIMO layers are accordingly received by user devices which also support the abovementioned techniques.

Plural MIMO layers transmitted from a base station may all be destined to one UE, and this case refers to the single-user MIMO mode (SU-MIMO); or otherwise they may be destined to different UEs, and this case refers to the multi-user MIMO mode (MU-MIMO).

Special reference signals (RSs) are used to enable communication between various devices in the 5G NR system, e.g. between base stations and user devices. A demodulation reference signal (DMRS) is one of such reference signals. DMRS signals are transmitted only within a respective physical channel (in particular, the following physical data channels: PDSCH and physical uplink shared data channel (PUSCH)). Therefore, they are not continuously or periodically transmitted reference signals which are associated with throughput overhead. In particular, a different DMRS signal is transmitted with each of PDSCH/PUSCH spatial MIMO layers simultaneously transmitted by a respective transmitting side; moreover, the same adaptive precoding is used with respect to the DMRS signal. In the 5G NR communication system, a unique index (number) referred to as a DMRS port is associated with every DMRS signal. Therefore, for instance, a DMRS port is unambiguously mapped to every PDSCH spatial MIMO layer transmitted from a TRP in the 5G NR communication system; thus, the number of MIMO layers is equal to the number of DMRS ports.

The flow of transmission of plural spatial MIMO layers in combination with DMRS signals is illustrated in FIG. 1.

FIG. 1 provides a simplified scheme of the spatial processing in the transmitter, where signal adaptive precoding, which converts an input signal of MIMO layers into a signal of digital antenna ports, is performed in the first step according to the related art. Furthermore, respective spatial processing in OFDM systems may be carried out in the frequency domain, thereby enabling to flexibly generate different beam patterns in different subcarriers. After the precoding procedure, the analog beamforming procedure is applied that converts a digital port input signal into signals of subarray physical antennas. This spatial signal processing is performed in the time domain for the entire OFDM signal, thereby imposing constraints onto the number of simultaneously generated beams.

The main purpose of DMRS signals is providing coherent reception of physical data channels (PDSCH and PUSCH). More precisely, during propagation through a communication channel each of transmitted MIMO layers is subjected to various distortions, and the channel estimation procedure is performed at the receiver side to correctly receive said MIMO layer, the algorithms of said procedure using a DMRS signal which corresponds to the MIMO layer. Channel estimation is a critical procedure in the 5G NR communication system, and reliability thereof is of exclusive significance. As a consequence, good reception of DMRS signals at the receiver side has great importance.

The 5G NR communication system uses, to simultaneously transmit plural DMRS signals of corresponding MIMO layers, respective multiplexing of said signals over resource elements (REs). In the context of multiplexing DMRS signals in the 5G NR communication system, two types of DMRS patterns are supported: Type 1 DMRS pattern and Type 2 DMRS pattern which are illustrated in the grid of resource elements in FIGS. 2A and 2B, where each RE is defined by a subcarrier in the frequency domain and an OFDM-symbol in the time domain.

FIGS. 2A and 2B are the 5G NR Type 1 DMRS pattern and the 5G NR Type 2 DMRS pattern, respectively, according to the related art.

First of all, subcarriers in the frequency domain are subdivided according to code-division multiplex (CDM) groups. Two CDM groups are defined for the Type 1 pattern, and in this case the distribution of subcarriers in the frequency domain has uniform nature, i.e., the spacing between subcarriers of different CDM groups is always the same (see FIG. 2A). The CDM groups are indexed by index Δ. Then, in each of the two CDM groups, DMRS signals are multiplexed by using length 2 frequency domain (FD) orthogonal cover codes (OCCs) and length 2 time domain (TD) OCCs. Each of the FD-OCCs and each of the TD-OCCs also has its own index. Therefore, 8 DMRS signals are multiplexed in the Type 1 pattern: 2 CDM groups×2 length 2 FD-OCCs×2 length 2 TD-OCCs, i.e., 8 DMRS ports are defined for respective 8 parallel spatial MIMO layers.

Three CDM groups with the non-uniform distribution in the frequency domain are defined for the Type 2 pattern (see FIG. 2B). Then, in each of the three CDM groups, DMRS signals are multiplexed again by using length 2 FD-OCCs and length 2 TD-OCCs. Therefore, 12 DMRS signals are multiplexed in the Type 2 pattern: 3 CDM groups×2 length 2 FD-OCCs×2 length 2 TD-OCCs, i.e., 12 DMRS ports are defined for respective 12 parallel spatial MIMO layers.

Thus, maximum 12 spatial MIMO layers are supported in the 5G NR communication system at the TRP side.

It should be emphasized that multiplexed DMRS signals in each CDM group of both the Type 1 pattern and the Type 2 pattern are orthogonal, i.e., do not cause interference. The orthogonality in the considered case has exclusive importance for correct reception of DMRS signals and, hence, for reliable channel estimation.

It should be noted herein that, though, in accordance with the aforesaid, up to 12 MIMO layers are generally supported at the TRP side, maximum 8 MIMO layers are supported in the SU-MIMO mode, i.e., not more than 8 MIMO layers may be simultaneously transmitted to one UE. Moreover, in the 5G NR communication system, semi-static switching between the Type 1 and Type 2 DMRS patterns is provided which is implemented by radio resource control (RRC) signaling when it is required to increase or decrease the maximum number of transmitted MIMO layers; in other words, the number thereof is not known a priori before the transmission. Therefore, a UE should know in advance which DMRS ports are to be used to receive a downlink (DL) data channel and transmit an uplink (UL) data channel.

The general scheme of informing a user device (UE) about used DMRS ports in the 5G NR system is given in FIG. 3.

FIG. 3 is a general scheme of informing a UE about DMRS ports to be used according to 5G NR according to the related art.

Referring to FIG. 3, a physical downlink control channel (PDCCH), which carries a control message in the form of downlink control information (DCI), is initially transmitted from a TRP to the UE. The DCI informs the user device about PDSCH/PUSCH signal transmission parameters chosen by a scheduler at the TRP side; first of all—that transmission of the PDSCH is scheduled to the user device. The DCI also conveys to the UE information about numbers of DMRS ports which are to be used for demodulating the scheduled number of MIMO layers of the PDSCH, as well as for scheduling transmission of the PUSCH. Moreover, the DCI may include other control information, for example, information about a modulation and coding scheme (MCS), frequency domain resource allocation (FDRA), adaptive precoding, and the like.

The informing disclosed above is relatively fast (in terms of low delays), since it is performed on the physical level in the compact DCI message. At the same time, this compactness implies strict constraint on the overall amount of bits in a DCI message (not more than 50-70 bits in the 5G NR system), and, therefore, information about used DMRS ports should be encoded into the DCI with minimization of bit overhead.

FIGS. 4A and 4B illustrate the approach to arrangement of data to implement informing a UE on DMRS ports to be used, as employed in the 5G NR system according to the related art. In accordance with the multiplexing discussed above, a unique set of a CDM group index, an FD-OCC, and an TD-OCC may be associated with every DMRS port. It should be noticed that the term ‘DMRS port’ is oftentimes directly referred to the unique combination of a CDM group, an FD-OCC, and a TD-OCC.

Referring to FIG. 4A, the correspondence of a DMRS port number to the combination of the parameters listed above is shown as a table for the Type 1 DMRS. For this DMRS type, where not more than four DMRS ports may be used at the UE side (i.e., the UE may receive or transmit not more than 4 spatial MIMO layers of a physical data channel at a time), FIG. 4B illustrates, as a table, encoding a combination of DMRS ports for usage (right column) with a code point (left column) which is in one-to-one correspondence with said combination. Namely a value of such a code point is transmitted from a TRP within the DCI to a UE to inform the UE on a specific DMRS port combination which is to be used for the PDSCH or for the PUSCH. It should be noticed herein that the notation of indices ‘0’, ‘1’, ‘2’, ‘3’ of DMRS ports, which is used in the right column of the table in FIG. 4B, is respectively equivalent to the notation of indices ‘1000’, ‘1001’, ‘1002’, ‘1003’ of DMRS ports, which is used in the left column of the table in FIG. 4A; said notations may be used interchangeably in the application in a way clear to a skilled artisan.

As to the middle column in the table of FIG. 4B, it should be noted that OFDM-symbols allocated for transmission of DMRS signals may be partially used to transmit a physical data channel (PDSCH or PUSCH). In particular, the code point for informing a UE on a combination of DMRS ports according to FIG. 4B is mapped to the number of CDM groups not used for data transmission. For example, for the code point equal to ‘0’, the first CDM group of a DMRS OFDM-symbol should be used for DMRS transmission, whereas the second CDM group should be used to transmit a physical data channel (PDSCH). For the code point equal to ‘3’, the physical data channel is not transmitted in an OFDM-symbol allocated for DMRSs. Moreover, the first and second CDM groups are used to transmit DMRSs for two or more users. Multiplexing of DMRSs with the data channel in one OFDM-symbol allows to reduce the overhead associated with the DMRS transmission.

FIGS. 5A, 5B, and 5C illustrate methods of allocating time resources in the 5G NR wireless communication system on the physical level according to the related art.

The 5G NR system supports two types of allocating time resources for transmission of a physical data channel: Type A and Type B. In FIG. 5A the former approach (Type A) is represented, wherein one downlink slot (DL slot) comprising 14 OFDM-symbols is the minimum unit of allocating time resources to transmit the PDSCH. The illustration of FIG. 5A is given for the frequency range with the carrier frequency of about 3.5 GHz, which is used in 5G NR. In a similar way, the minimum unit of allocating time resources to transmit the PUSCH is one slot (UL slot). Type A is characterized by the limited capability of varying a start OFDM-symbol (from 0^{th} to 3^{rd}) of the data channel within a slot.

FIG. 5B illustrates the example of allocating time resources according to the Type A scheme in a greater time interval. In the system, each frame having length of 10 ms is divided into a number of “downlink transmission-uplink transmission” periods (DL/UL-periods) each including a respective number of DL slots and UL slots separated by a guard interval to enable switching between DL and UL.

Referring to FIGS. 5A and 5B, in each DL/UL slot, OFDM-symbols are allocated for transmitting a physical control channel and DMRS signals. It should be noted that the ratio between the number of DL slots and UL slots in a DL/UL-period is flexibly configurable.

Type A is typically used for enhanced mobile broadband (eMBB) traffic, which corresponds, for example, to ordinary Internet traffic in smartphones.

FIG. 5C illustrates the latter of the time resource allocation types used in 5G NR, in particular, Type B, wherein the minimum unit of allocating time resources is a mini-slot. In this case, a user may be allocated, within a slot, with one or more PDSCH transmissions, each having length of one mini-slot comprising 2 (as shown in FIG. 5C), 4, or 7 OFDM-symbols. A physical downlink control channel (DL-ctrl) is typically associated with each of such PDSCH transmissions; each mini-slot also comprises DMRS signals (not shown in FIG. 5C). The same applies to PUSCH transmissions. This type, in particular, is characterized by greater flexibility of the data channel start symbol (from 0^{th} to 12^{th}) within a slot. Information about start symbols of PDSCH mini-slots is signaled to a UE in the DL-ctrl.

Type B is typically used for ultra-reliable low-latency communication (URLLC) traffic which is mostly used for communications in industrial applications (e.g. between robots etc.), where demands to fidelity/reliability and to latency are high.

It should be emphasized once again that the exemplified configurations of a frame, slot, mini-slot are flexible in 5G NR to a substantial extent, and FIGS. 5A to 5C are given solely as illustrations in order to provide exhaustive understanding of the application.

Finally, though, in accordance with the foregoing disclosure, DMRS signals, transmitted from one base station are orthogonal, i.e., they do not cause interference to each other within the cell served by the base station, nevertheless, orthogonality between DMRS signals of neighboring cells is initially lacking, which may cause interference at cell boundaries. In order to randomize interference, quadrature phase shift-keying (QPSK) modulation is also performed with respect to DMRS signals transmitted from the base stations. In the 5G NR system, QPSK modulation is performed by a Gold sequence of length 31 with initialization common over CDM groups or specific to each CDM group. In the latter case, two initial initializing values (seeds) are configured for each base station by the RRC signaling and dynamically signaled to UEs by the DCI for subsequent demodulation. Therefore, sets of initializing values are different for different TRPs, thereby providing diversity of DMRS signals transmitted by the different TRPs. It should be noticed that a similar procedure is also applied in UL to randomize interference between DMRS signals from users served by neighboring TRPs.

The aspects of operating 5G NR wireless communication systems, as briefly discussed above, are disclosed in detail in specifications TS 38.211, 38.212 “NR; Physical channels and modulation”, v17.3.0, 2022-09-21, 3gpp.org, which are entirely incorporated into the description by reference.

Though deployment of 5G NR systems in the world is only spinning up, nevertheless active research is being already carried out now in different directions for standardization of next generation wireless communication systems, so called 6^{th} generation (6G), which will have characteristics exceeding 5G NR.

In particular, for the 6G operating range of 10-12 GHz (UPPER MID BAND), it is planned to support, at base stations (TRPs), ultra-large antenna arrays, with at least 1024 antenna elements, hybrid analog and digital beamforming with a large number of antenna ports (≥128). Therefore, by supporting, in particular, up to 64 simultaneously transmitted spatial MIMO layers in UPPER MID BAND communication systems, the concept of a radio interface with the ultra-large antenna array (xMIMO) will be rendered to a principally new level.

Support of a set of reference signals similar to the one used in 5G NR, such as DM-RS, CSI-RS, SRS, PT-RS, PSS/SSS, is planned in 6G. Details regarding the listed RSs are given in the abovementioned specifications. At the same time, the approaches to operating on the reference signals, as applied in 5G NR, may not be always extrapolated to next generation wireless communication systems.

For instance, the abovementioned DMRS patterns used in 5G NR systems may enable to multiplex maximum 12 DMRS signals, whereas parallel transmission of at least 64 spatial MIMO layers and, hence, 64 DMRS signals should be provided in the 6G system. In other words, the existing DMRS patterns may not enable to multiplex the number of DMRS signals required for 6G.

Then, as recited above with reference to FIGS. 2A and 2B, non-uniform distribution of subcarriers in the frequency domain is typical to the Type 2 DMRS pattern, unlike the uniform nature of the Type 1 pattern. Substantially different channel estimation algorithms are used for these two DMRS pattern types; furthermore, greater complexity is typical for the algorithm of the non-uniform Type 2 DMRS pattern. This is not a serious problem for the relatively small number of DMRS ports in 5G NR, however, it may turn out to be inacceptable for the significantly greater number thereof in 6G, since complexity of the channel estimation algorithm significantly increases in the case of the abovementioned non-uniformity.

Then, if the necessity occurs to adjust density of a DMRS pattern in the frequency domain (in view of adjusting the number of available DMRS ports), respective switching is performed in the 5G NR communication system between the Type 1 and Type 2 DMRS patterns having the different channel estimation algorithms associated therewith, which are different in terms of complexity inter alia. Moreover, in accordance with the aforesaid, said switching has semi-static nature, i.e., dynamic switching between the Type 1 and Type 2 patterns is not supported in 5G NR. In other words, there is rather limited flexibility of the DMRS pattern adaptation, with the switching between the substantially inconsistent pattern types. In 6G, implementation of such an approach would lead to inacceptable growth of complexity at the receiver side.

Therefore, there is an urgent need in designing a new DMRS pattern for next generation communication systems (including 6G) that would satisfy the following design requirements:
support of a greater number of DMRS ports (up to 64);
adaptability of the DMRS pattern depending on capacity requirements, with the capability of varying its density in time and frequency, without modifying the DMRS pattern itself;
maintenance of low complexity of the channel estimation algorithm.

Technical solutions are known from the art which relate to DMRS patterns. Such technical are provided, for instance, in U.S. Ser. No. 11/218,241, US 2022/0166566, US 2017/0288837.

U.S. Ser. No. 11/218,241 provides a method of operating a terminal in a wireless communication system, the method comprising: identifying DMRS type information and DMRS symbol length information; identifying port number information for receiving DMRS, and receiving the DMRS based on the DMRS type information, the DMRS symbol length information, and the port number information, wherein the port number information indicates a port number for the terminal in DMRS information including parameters for CDM group information, offset information, FD-OCC information, and TD-OCC information corresponding respectively to multiple port numbers, wherein the DMRS information is defined per DMRS type. U.S. Ser. No. 11/218,241 basically describes the 5G NR DMRS pattern and indication of DMRS ports with RRC-based type adaptation, i.e., the adaptation is performed not on the physical level.

US 2022/0166566 provides a method for dynamic configuration of DMRSs that may be performed by a base station and includes the steps of: receiving one or more uplink signals from at least one UE; estimating a Doppler shift associated with the one or more uplink signals; determining a density of reference signals within a slot for the at least one UE based, at least in part, on the estimated Doppler shift associated with the one or more uplink signals; and transmitting information to the at least one UE indicating an allocation of reference signal resources for the UE, wherein the allocation of the reference signal resources is based on the density of the reference signals for the at least one UE. US 2022/0166566 basically discloses only DMRS density adaptation in the time domain, without association to a specific DMRS pattern; the Doppler shift is used therein as a factor to change the DMRS density.

US 2017/0288837 provides a method of multiplexing reference signals for MIMO layers, the method comprising: assigning resources for DMRSs corresponding to each of two or more data streams, wherein the resources assigned to each of the data streams are staggered in frequency and span two or more OFDM symbols; and transmitting the DMRSs using the assigned resources. Furthermore, frequency-division multiplex (FDM) and time-division multiplex (TDM) is used in US 2017/0288837 to multiplex antenna ports, whereas TDM is not efficient for UL transmission due to on/off power amplifier issue.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. an aspect of the disclosure is to provide a DMRS pattern to multiplex DMRS signals for communicating in a wireless communication system supporting plural spatial MIMO layers, so that the pattern enables to avoid the respective drawbacks of the existing DMRS patterns described above. More specifically, the DMRS pattern to be provided should enable to support a greater number of DMRS ports (up to 64), adaptation of the DMRS pattern depending on throughput requirements, with the capability of varying its density over frequency and time without modification of the DMRS pattern itself, and maintenance of low complexity of the channel estimation algorithm at the receiver side.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, by the UE from a base station, at least one configuration information associated with a demodulation reference signal (DMRS), identifying, by the UE, at least one of a code division multiplexing (CDM) group, a frequency domain (FD) orthogonal cover code (OCC), and a time domain (TD) OCC for the DMRS based on the at least one configuration information, and receiving, by the UE from the base station, the DMRS based on the at least one of the CDM group, the FD OCC, and the TD OCC, wherein a number of CDM groups is 4, wherein the FD OCC includes at least one of (+1,+1,+1,+1), (+1,−j,+1,+j), (+1,−1,+1,−1), and (+1,+j,−1,−1), and wherein the TD OCC includes at least one of (+1,+1,+1,+1), (+1,−j,+1,+j), (+1,−1,+1,−1), and

In accordance with another aspect of the disclosure, a method performed by a base station in a wireless communication system is provided. The method includes transmitting, by the base station to a user equipment (UE), at least one configuration information associated with a demodulation reference signal (DMRS), wherein the at least one configuration information indicates at least one of a code division multiplexing (CDM) group, a frequency domain (FD) orthogonal cover code (OCC), and a time domain (TD) OCC for the DMRS, mapping, by the base station, the DMRS to resource elements (REs) based on the at least one of the CDM group, the FD OCC, and the TD OCC, and transmitting, by the base station to the UE, the DMRS, wherein a number of CDM groups is 4, wherein the FD OCC includes at least one of (+1,+1,+1,+1), (+1,−j,+1,+j), (+1,−1,+1,−1), and (+1,+j,−1,−1), and wherein the TD OCC includes at least one of (+1,+1,+1,+1), (+1,−j,+1,+j), (+1,−1,+1,−1), and (+1,+j,−1,−1).

In accordance with another aspect of the disclosure, a user equipment (UE) in a wireless communication system is provided. The UE includes transceivers, memory storing one or more computer programs, and one or more processors communicatively coupled to the transceivers and the memory, wherein the one or more computer programs include computer-executable instructions that, when executed collectively by the one or more processors, cause the UE to receive, from a base station, at least one configuration information associated with a demodulation reference signal (DMRS), identify at least one of a code division multiplexing (CDM) group, a frequency domain (FD) orthogonal cover code (OCC), and a time domain (TD) OCC for the DMRS based on the at least one configuration information, and receive, from the base station, the DMRS based on the at least one of the CDM group, the FD OCC, and the TD OCC, wherein a number of CDM groups is 4, wherein the FD OCC includes at least one of (+1,+1,+1,+1), (+1,−j,+1,+j), (+1,−1,+1,−1), and (+1,+j,−1,−1), and wherein the TD OCC includes at least one of (+1,+1,+1,+1), (+1,−j,+1,+j), (+1,−1,+1,−1), and (+1,+j,−1,−1).

In accordance with another aspect of the disclosure, a base station in a wireless communication system is provided. The base station includes transceivers, memory storing one or more computer programs, and one or more processors communicatively coupled to the transceivers and the memory, wherein the one or more computer programs include computer-executable instructions that, when executed collectively by the one or more processors, cause the base station to transmit, to a user equipment (UE), at least one configuration information associated with a demodulation reference signal (DMRS), wherein the at least one configuration information indicates at least one of a code division multiplexing (CDM) group, a frequency domain (FD) orthogonal cover code (OCC), and a time domain (TD) OCC for the DMRS, map the DMRS to resource elements (REs) based on the at least one of the CDM group, the FD OCC, and the TD OCC, and transmit, to the UE, the DMRS, wherein a number of CDM groups is 4, wherein the FD OCC includes at least one of (+1,+1,+1,+1), (+1,−j,+1,+j), (+1,−1,+1,−1), and (+1,+j,−1,−1), and wherein the TD OCC includes at least one of (+1,+1,+1,+1), (+1,−j,+1,+j), (+1,−1,+1,−1), and (+1,+j,−1,−1).

In accordance with another aspect of the disclosure, one or more non-transitory computer-readable storage media storing one or more computer programs including computer-executable instructions that, when executed collectively by one or more processors of a user equipment (UE), cause the UE to perform operations are provided. The operations include receiving, by the UE from a base station, at least one configuration information associated with a demodulation reference signal (DMRS), identifying, by the UE, at least one of a code division multiplexing (CDM) group, a frequency domain (FD) orthogonal cover code (OCC), and a time domain (TD) OCC for the DMRS based on the at least one configuration information, and receiving, by the UE from the base station, the DMRS based on the at least one of the CDM group, the FD OCC, and the TD OCC, wherein a number of CDM groups is 4, wherein the FD OCC includes at least one of (+1,+1,+1,+1), (+1,−j,+1,+j), (+1,−1,+1,−1), and (+1,+j,−1,−1), and wherein the TD OCC includes at least one of (+1,+1,+1,+1), (+1,−j,+1,+j), (+1,−1,+1,−1), and (+1,+j,−1,−1).

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an illustrative scheme of spatial processing of signals at the transmitter side according to the related art;

FIGS. 2A and 2B are the 5G NR Type 1 DMRS pattern and the 5G NR Type 2 DMRS pattern, respectively, according to the related art;

FIG. 3 is a general scheme of informing a UE about DMRS ports to be used according to 5G NR according to the related art;

FIGS. 4A and 4B are an illustration of the approach according to 5G NR for informing a UE about DMRS ports to be used according to the related art;

FIGS. 5A, 5B, and 5C are an illustration of allocating time resources in 5G NR according to the related art;

FIG. 6 is an illustrative scheme of a wireless communication system according to an embodiment of the disclosure;

FIG. 7 is a schematic representation of the DMRS pattern according to an embodiment of the disclosure;

FIG. 8 is a schematic representation of the DMRS pattern according to an embodiment of the disclosure;

FIG. 9 is a flowchart of an embodiment of the method for multiplexing DMRS signals according to an embodiment of the disclosure;

FIG. 10 is a schematic representation of the adapted DMRS pattern according to an embodiment of the disclosure;

FIG. 11 is a flowchart of an embodiment of the wireless communication method according to an embodiment of the disclosure;

FIGS. 12A, 12B, 12C, and 12D are illustrative embodiments of adaptation according to various embodiments of the disclosure;

FIGS. 13A and 13B are an illustration of selecting a reduced DFT OCC configuration according to various embodiments of the disclosure;

FIG. 14 is a flowchart of another embodiment of the wireless communication method according to an embodiment of the disclosure;

FIG. 15 is a flowchart of the method of indicating DMRS ports for a UE according to an embodiment of the disclosure;

FIGS. 16A, 16B, and 17 are an illustration of the tree hierarchy of DMRS port groups and encoding them according to various embodiments of the disclosure;

FIG. 18 is a flowchart of the method of indicating DMRS ports for a UE according to an embodiment of the disclosure;

FIGS. 19A, 19B, and 19C are illustrations of the table representation of adjacent DMRS port groups according to various embodiments of the disclosure;

FIG. 20 is a flowchart of the method of indicating DMRS ports for a UE according to an embodiment of the disclosure;

FIG. 21 is an example of encoding a combination of DMRS ports an of the FIG. 20 according to an embodiment of the disclosure;

FIG. 22A is an illustration of the general approach to preprocessing the DMRS port table for the case of excluding part of DMRS ports according to an embodiment of the disclosure;

FIG. 22B is an example of implementation of the general approach of FIG. 22A according to an embodiment of the disclosure;

FIG. 23 is an illustration of an attempt to use the 5G NR approach to allocating time resource in a next generation wireless communication system according to an embodiment of the disclosure;

FIGS. 24A and 24B are embodiments of aggregating time domain resources for the DL part of a DL/UL period of a frame according to various embodiments of the disclosure;

FIGS. 25A and 25B are a high-level representation of resource aggregation according to various embodiments of the disclosure;

FIGS. 26A and 26B are illustrations of periodic allocation of DMRS sub-bundles when allotting time domain resources according to various embodiments of the disclosure;

FIG. 27 is an illustration of aggregating time domain resources to provide pipelining of processing of code blocks at the receiver side according to an embodiment of the disclosure; and

FIGS. 28A and 28B are a flowchart of the method of allocating resources in the time domain according to various embodiments of the disclosure.

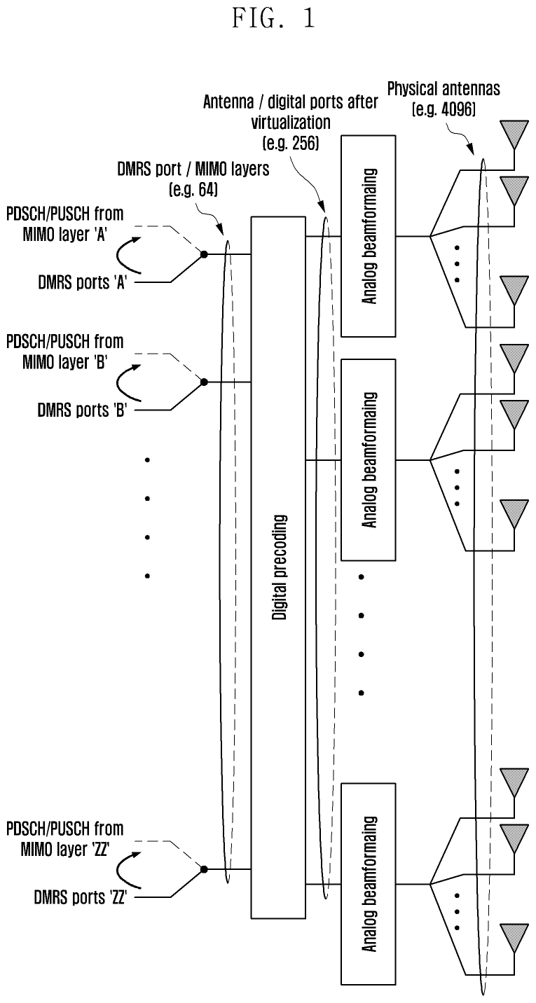

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalent. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

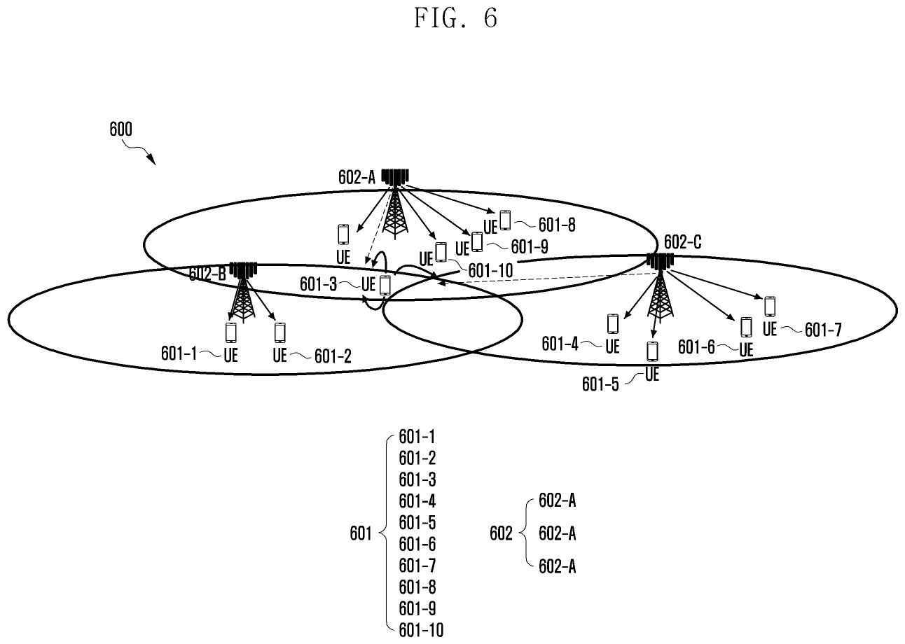

FIG. 6 generally illustrates a wireless communication system according to an embodiment of the disclosure.

Referring to FIG. 6, user equipments (UEs) 601 (i.e., UEs 601-1, 601-2, 601-3, 601-4, 601-5, 601-6, 601-7, 601-8, 601-9, 601-10) communicate with base stations (TRPs) 602 in a radio access network (RAN) 600. UEs 601 (e.g., UE 601-1, 601-2, 601-3, . . . ) are distributed over the RAN 600, and each of the UEs 601 may be fixed or mobile. Broadly known examples of UEs are smartphones, tablets, modems, and the like.

The base stations 602 (e.g., the TRPs 602-A, 602-B, 602-C) may provide coverage for a specific geographic area oftentimes referred to as ‘cell’. The base stations 602 basically have fixed structure, but they may have mobile implementation as well. In general, the base stations may represent macro-TRPs (as illustrated by the TRPs 602-A, 602-B, 602-C in FIG. 6), as well as pico-TRPs for pico-cells or femto-TRPs for femto-cells. Cells in turn may be divided into sectors.

Coordination and management of operation of the base stations 602 may be provided by a network controller which is in communication therewith (i.e., via a backhaul connection). The RAN 600 may be in communication with a core network (CN) (e.g., via the network controller) which provides various network functions, such as e.g. access and mobility management, session management, authentication server function, application function, and the like. Moreover, the base stations 602 in the RAN 600 may also connect to each other (i.e., via a direct physical connection).

When a user equipment is moving within the RAN 600, handover of the device from one TRP to another TRP may be performed. For example, the UE 601-3 may be handed over from the TRP 602-B to the TRP 602-A. While performing this, respective operation parameters of the UE are reconfigured for operation with the new TRP. The UE may be also handed over between sectors of one TRP.

In the 5G NR wireless communication system the Cloud RAN (C-RAN) concept is implemented that refers to dividing a base station into three parts and using a special interface defined to exchange information between these functional parts. In particular, the TRP may be divided into a radio unit (RU) which carries out radio transceiver functions, a distributed unit (DU) for L1 (physical level) and L2 (MAC level) computations, and a centralized unit for L2 and L3 (RRC level) computations. Such a division enables to centralize CUs in a respective central network node, whereas DUs may be distributed to a greater extent in cell nodes. In this case switchings of connections between cell nodes may be performed on the L1 level, i.e., with relatively small delays. Support of this concept is also expected in wireless communication networks of next generations.

It should be noticed that the description according to FIG. 6 and said figure itself have exclusively illustrative, non-limiting nature with the aim of outlining the general operation environment of the disclosure. Though only known basic components of the communication system are illustrated in FIG. 6, it should be appreciated that the communication system may further include plural other elements.

Each of the TRPs 602 shown in FIG. 6 includes hardware and logical means to implement respective functions in the TRP. The hardware means refer to, in particular, an antenna array comprised of transceiving antenna elements which have been discussed above, various specially configured processors, controllers, data storage devices, other circuit elements, as well as buses connecting them. The logical means refer to software which is stored in respective memory devices and configures respective circuit elements. Firmware directly hardwired in processors and controllers also refers to the software. The abovementioned hardware means are configured inter alia to perform various processing with respect to transmitted and received signals, including (de)modulation, (de)multiplexing, (de)coding, amplifying, filtering, digitizing, (de)interleaving, resource allocation, reception/transmission scheduling.

In a similar way, each of the UEs 601 shown in FIG. 6 includes hardware and logical means to implement respective functions in the UE. The hardware means refer to, in particular, transceiving devices with respective antenna elements, various specially configured processor(s), controllers, data storage devices, other circuit elements, as well as buses connecting them. The logical means refer to software which is stored in respective memory devices and configures respective circuit elements. Firmware directly hardwired in controllers also refers to the software. The indicated hardware means are configured inter alia to perform various processing with respect to transmitted and received signals, including (de)modulation, (de)multiplexing, (de)coding, amplifying, filtering, digitizing, (de)interleaving. Moreover, the UE comprises means to interact with a user, including a touch screen, speakers/microphone, buttons, as well as user applications which are stored in the memory of the UE and executed by the processor of the UE in a respective operating system.

Examples of the abovementioned processors/controllers include microprocessors, microcontrollers, digital signal processors (DSPs), field programmable gate arrays (FPGAs), discrete hardware integrated circuits, and the like. Firmware/software executed by the processors/controllers should be understood broadly, as referring to computer-executable instructions, instruction sets, program code, code segments, subroutines, program modules, objects, procedures, and the like. The software is stored in respective computer-readable media which may be implemented e.g. in the form of random-access memory (RAM), read-only memory (ROM), electrically erasable programmable (EEPROM), solid state storage devices, magnetic storage devices, optical storage devices, and the like, which may be recorded with respective program codes and data structures that may be accessed by respective processors/controllers.

The hardware and software elements of TRPs and UEs, as listed above, are configured for enabling to perform, in the TRPs and UEs, the methods according to the application which are described hereinbelow. Implementation itself of the component hardware means of the TRPs and the UEs and specific configuring thereof, including by respective logical means, is known in the technical field which the application relates to. Moreover, various functions according to the methods of the application may be performed in plural separate elements or in one or more integral elements, as defined by design structural characteristics.

### I. Multiplexing DMRS Signals

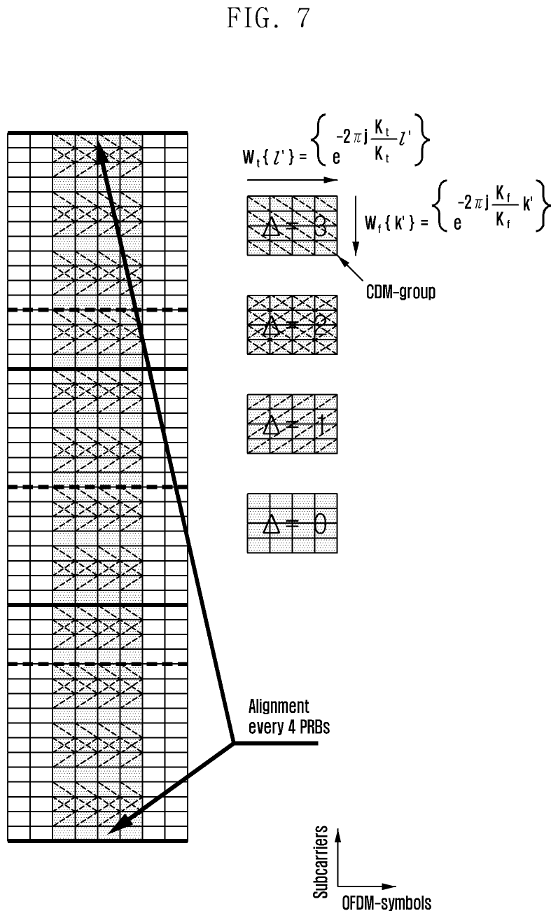

The method of multiplexing DMRS signals for broadband transmission according to the disclosure is described hereinafter with reference to FIGS. 7, 8, and 9.

The method provided herein is performed in a transmitting side communication device in a wireless communication system; preferably, in a next generation communication system. The transmitting side communication device supports simultaneous transmission of a plurality of spatial MIMO layers to transmit one physical data channel. As recited previously, a different DMRS signal is associated with each of the plurality of MIMO layers. The transmitting side communication device may be a TRP (e.g., the TRP 602 of FIG. 6), and in this case the physical data channel is the PDSCH. Alternatively, the transmitting side communication device may be a UE (i.e., the UE 601 of FIG. 6), and in this case the physical data channel is the PUSCH.

The description will be provided hereinbelow, without loss of generality, of the case when the transmitting side communication device is the TRP.

As discussed above, in the 6G wireless communication system, for the 10-12 GHz range, support of a significantly greater number of MIMO layers than in 5G NR is implied. The case of 64 simultaneously transmitted spatial MIMO layers will be considered hereinafter as a preferable embodiment of the disclosure. As will be shown below, the technical solution provided herein encompasses cases of both a greater and smaller number of MIMO layers.

FIG. 7 illustrates the DMRS pattern in the time-frequency grid of resource elements (REs) according to an embodiment of the disclosure.

The DMRS pattern provides multiplexing of 64 DMRS signals for 64 spatial MIMO layers of the PDSCH, respectively. That is, the DMRS signals are multiplexed over the resource elements of the DMRS pattern.

As noted above, in the time-frequency grid every resource element is defined by an OFDM subcarrier in the frequency domain and by an OFDM-symbol in the time domain. According to OFDM, the frequency range of the system is divided into a plurality of subcarriers, and each of the OFDM subcarriers may be modulated with data. The total number of OFDM subcarriers depends on the system frequency range, and a spacing between neighboring subcarriers may be fixed or varying. In particular, in 5G NR the basic subcarrier spacing (SCS) of 15 kHz is supported; furthermore, other SCSs are supported relative to the basic SCS, for example, 30 kHz, 60 kHz, 120 kHz, 240 kHz, and the like.

Referring to FIG. 7, the OFDM subcarriers in the DMRS pattern provided herein is related to one of four CDM groups. Each of the CDM groups depicted in FIG. 7 has its own index Δ, from 0 to 3, and is shown in a distinguishable way. In each of the CDM groups, modulation of DMRS signals is performed by applying digital Fourier transform (DFT) based FD-OCCs (DFT FD-OCCs) of length 4 and DFT-based TD-OCCs (DFT TD-OCCs) of length 4.

In general, DFT FD-OCCs are defined by the following equation

$${w}_{f} ( {l}^{′} ) = \{ {e}^{- 2 π j \frac{{k}_{f}}{{k}_{f}} {l}^{′}} \} , {l}^{′} = 0 , … , {K}_{f} - 1 \qquad Equation 1$$

where k_{f} is the frequency domain orthogonal cover code index, K_{f} is the code length, j is imaginary unit. In the considered case, K_{f}=4, and the possible DFT FD-OCCs are illustrated in Table 1.

TABLE 1

| k_{f} | w_{f}(0) | w_{f}(1) | w_{f}(2) | w_{f}(3) |
|---|---|---|---|---|
| 0 | +1 | +1 | +1 | +1 |
| 1 | +1 | −j | −1 | +j |
| 2 | +1 | −1 | +1 | −1 |
| 3 | +1 | +j | −1 | −j |

In a similar way, in general, DFT TD-OCCs are defined by the following equation

$${w}_{t} ( {k}^{′} ) = \{ {e}^{- 2 π j \frac{{k}_{t}}{{K}_{t}} {k}^{′}} \} , {k}^{′} = 0 , … , {K}_{t} - 1 \qquad Equation 2$$

where kₜ is the time domain orthogonal cover code index, Kₜ is the code length. In the considered case, Kₜ=4, and the possible DFT TD-OCCs are illustrated in Table 2.

TABLE 2

| kₜ | wₜ(0) | wₜ(1) | wₜ(2) | wₜ(3) |
|---|---|---|---|---|
| 0 | +1 | +1 | +1 | +1 |
| 1 | +1 | −j | −1 | +j |
| 2 | +1 | −1 | +1 | −1 |
| 3 | +1 | +j | −1 | −j |

As a result, DMRS signals in every CDM group are mutually orthogonal.

As a consequence, the DMRS pattern proposed herein provides orthogonal multiplexing of 64 DMRS signals: 4 CDM groups×4 DFT FD-OCCs of length 4×4 DFT TD-OCCs of length 4.

As seen from FIG. 7, the DMRS pattern continuously repeats over the plurality of OFDM subcarriers; moreover, said pattern is uniform in the frequency domain—the spacing between subcarriers of any one CDM group in the DMRS pattern is the same, thereby complexity of the channel estimation algorithm is in turn maintained at a relatively low level in the receiving side.

As reported above, the DMRS pattern described above is preferable but not the only possible.

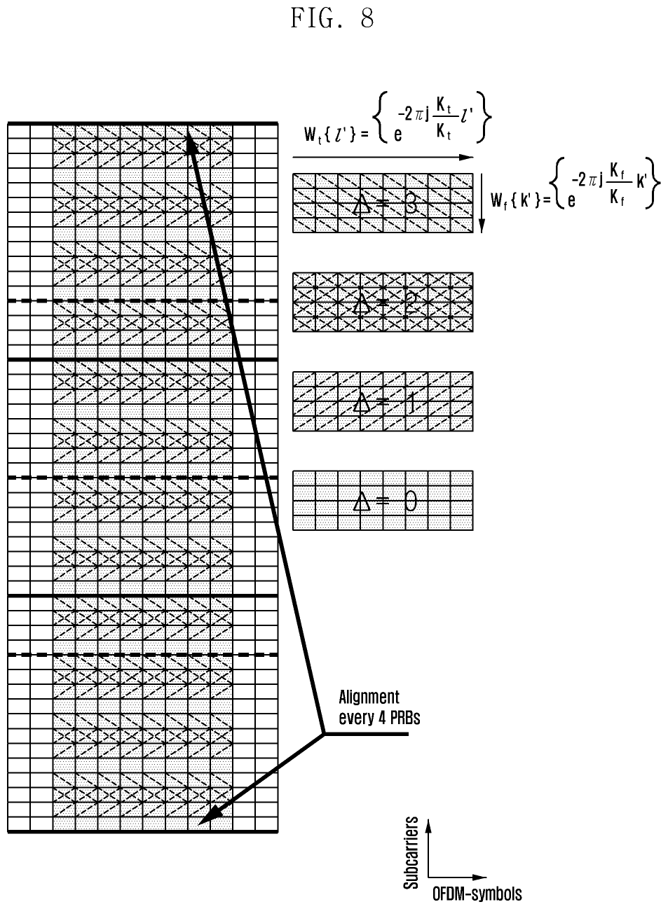

FIG. 8 shows the uniform DMRS pattern according to an embodiment of the disclosure that provides orthogonal multiplexing of 128 DMRS signals for 128 simultaneously transmitted spatial MIMO layers of the PDSCH, respectively, by using DFT TD-OCCs of length 8, i.e., Kₜ=8 in Equation 2.

In modern communication systems, scheduling of resources in the frequency domain is performed not in terms of separate subcarriers, but with a certain granularity. In particular, in the 5G NR wireless communication system a minimum unit of allocation of resources in the frequency domain is 1 resource block (RB) comprised of 12 successive OFDM subcarriers.

Referring to FIGS. 7 and 8, the boundary of the DMRS pattern according to the disclosure, which comprises 16 successive OFDM subcarriers in the frequency domain, will not match the boundary of one RB. That is why it is proposed in the disclosure to carry out scheduling of resources for transmission with such a granularity that in the frequency domain the boundary of the integer number S of successive DMRS patterns is aligned with the integer number P_{PRB} of successive PRBs. In the case illustrated in FIGS. 7 and 8, scheduling of resources in the frequency domain should be performed with the granularity of 4 PRBs (P_{PRB}=4) which will contain 3 successive DMRS patterns (S=3). Other granularities of resource scheduling will be shown hereinbelow.

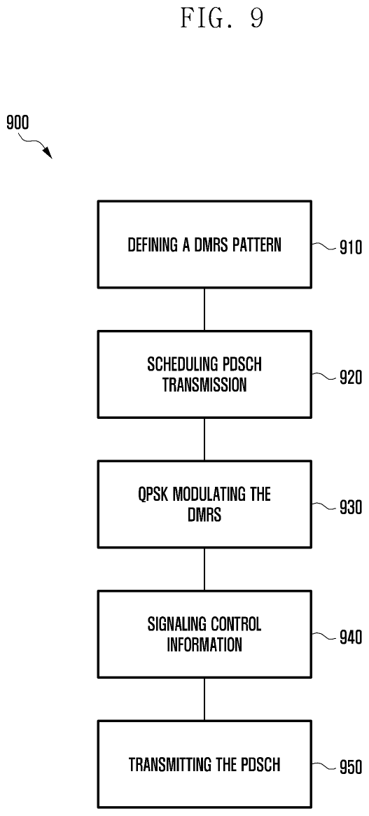

FIG. 9 is a flowchart of an embodiment of the method for multiplexing DMRS signals according to an embodiment of the disclosure.

Referring to FIG. 9, a method 900 of multiplexing DMRS signals according to the disclosure is described hereinafter. As an illustration, but not limitation, the method 900 is performed in a base station (e.g., the TRP 602 of FIG. 6) which supports simultaneous transmission of a plurality of PDSCH spatial MIMO layers.

In operation 910, for N MIMO layers (N is a positive integer) a DMRS pattern is defined which is comprised of resource elements (REs) over which respective N DMRS signals are multiplexed. Each of OFDM subcarriers in the DMRS pattern is related to one of L CDM groups in such a way that a spacing between OFDM subcarriers of any one CDM group in the DMRS pattern is the same. In every CDM group, multiplexing of DMRS signals is provided by applying DFT FD-OCCs of length K_{f} and DFT TD-OCCs of length Kₜ. As recited above, the DMRS pattern continuously repeats over the plurality of OFDM subcarriers in the frequency domain.

For the case considered in FIG. 7, L=4, K_{f}=4, Kₜ=4 and, accordingly, N=64; for the case considered in FIG. 8, L=4, K_{f}=4, Kₜ=8 and, accordingly, N=128. Examples with other values of said integer parameters will be given below. It should be noticed herein that K_{f} according to the disclosure may also have the value equal to 8.

As discussed earlier, operation 910 of the method 900 may be performed in a UE supporting broadband transmission, evidently keeping in mind that the UE supports a smaller maximum number of simultaneously transmitted MIMO layers than the TRP. In particular, for the case of the planned support of 64 DMRS ports in the TRP for 6G 10-12 GHz, as discussed above, maximum 16 DMRS ports will be supported in the UE.

The method 900 may include subsequent steps performed in the TRP which are associated with using the DMRS pattern defined in operation 910 for communication.

So, in operation 920 a scheduler of the TRP schedules transmission of the PDSCH to one or more UEs (i.e., the UE 601 of FIG. 6) by using N MIMO layers. Furthermore, in this step, the TRP scheduler may also schedule transmission of the PUSCH from the UE.

In operation 940, the TRP signals control information to the UEs. The control information comprises information about the DMRS pattern defined in operation 910, including at least the parameters L, K_{f}, and Kₜ. The aspects of signaling DMRS-related information to the UE are described in more detail below.

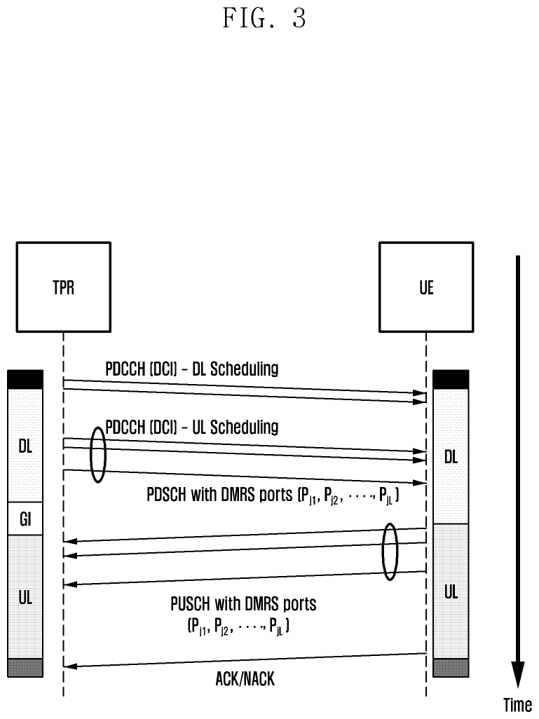

According to the preferable embodiment, the control information is transmitted to the UE in DCI carried by the PDCCH. The DCI also comprises other information, as outlined above with reference to FIG. 3. In particular, the UE is also informed through the DCI that the transmission is scheduled for it.

In accordance with other embodiments, the control information may be transmitted to the UE in the RRC (i.e., L3) level or in the MAC (i.e., L2) level which are higher levels as compared to the physical (i.e., L1) level in which the DCI is transmitted.

In operation 950, the TRP performs the scheduled broadband transmission of the PDSCH.

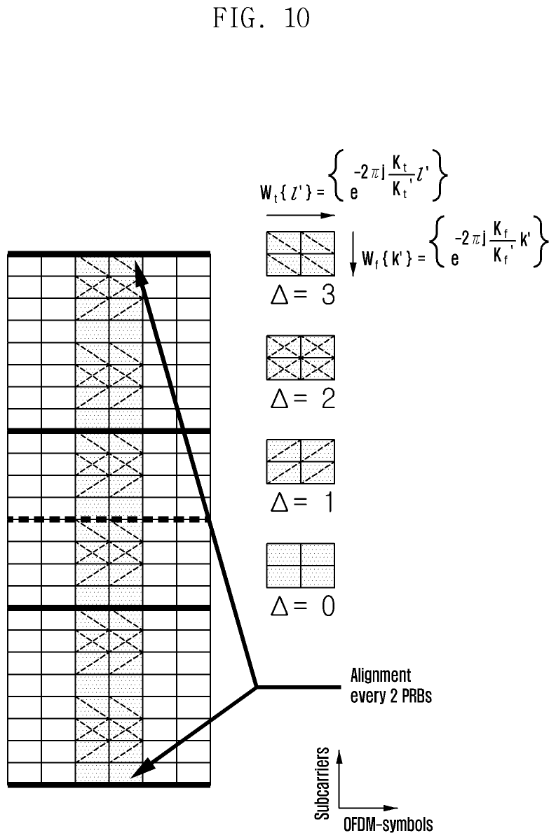

Embodiments of adaptation of the DMRS pattern provided according to the disclosure will be described hereinbelow with reference to FIGS. 10, 11, 12A to 12D, 13A, 13B, and 14

The necessity of such adaptation may arise in cases where transmission of a great number (e.g. 64) of spatial MIMO layers is not needed more, for example, in view of decrease in consumer load onto a data channel, and in such a case they are reduced in a base station. The DMRS pattern should be naturally adapted to such reduction by respectively decreasing a number of DMRS signals orthogonally multiplexed therein, or, in other words, by respectively reducing DMRS capacity.

One embodiment of the adaptation is underlain by the fact that DFT OCCs are well parameterizable. In particular, FIG. 10 shows the adaptation (sub-sampling) of the DMRS pattern by setting the DFT FD-OCC length K_{f}′ and the DFT TD-OCC length Kₜ′ both equal to 2 (see Equations 1 and 2), with said four CDM groups.

This DMRS pattern, which continuously repeats over the plurality of OFDM subcarriers, enables to orthogonally multiplex 16 DMRS ports for 16 MIMO layers, respectively. Said adapted pattern has smaller DMRS capacity, but it is at the same time characterized by less overhead, as well as by higher quality of channel estimation due to higher DMRS density in the frequency domain.

FIG. 10 is a schematic representation of the adapted DMRS pattern according to an embodiment of the disclosure.

Referring to FIG. 10, scheduling of resources in the frequency domain in the case of this adaptation will be carried out with granularity of 2 PRBs which will contain 3 successive DMRS patterns.

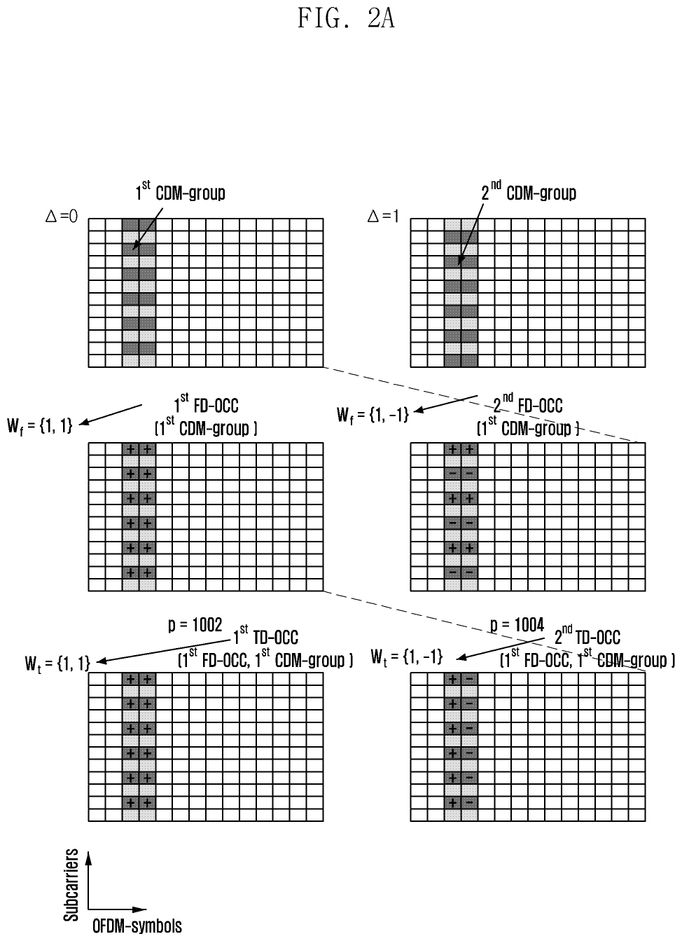

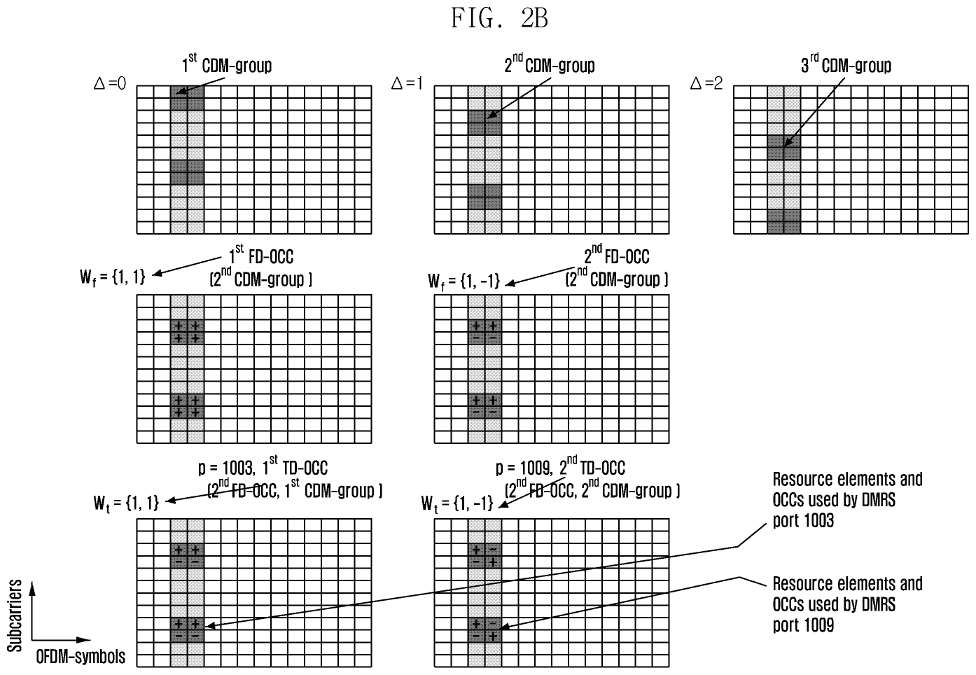

An additional possible implementation of the considered one embodiment is adaptation of the DMRS pattern by using two CDM groups and setting the DFT FD-OCC length and the DFT TD-OCC length both equal to 2. The adapted DMRS pattern obtained in such a way provides orthogonal multiplexing of 8 DMRS ports for 8 MIMO layers, respectively. It should be emphasized that said adapted DMRS pattern exactly matches the 5G NR Type 1 DMRS pattern discussed above with reference to FIG. 2A. Therefore, the DMRS pattern according to the disclosure has backwards compatibility, and it may be used in existing wireless communication systems.

It should be noted in view of the aforesaid that the DMRS pattern shown in FIG. 7 may be obtained through adapting the DMRS pattern shown in FIG. 8 by setting the DFT TD-OCC length equal to 4 while maintaining the DFT FD-OCC length and the four CDM groups.

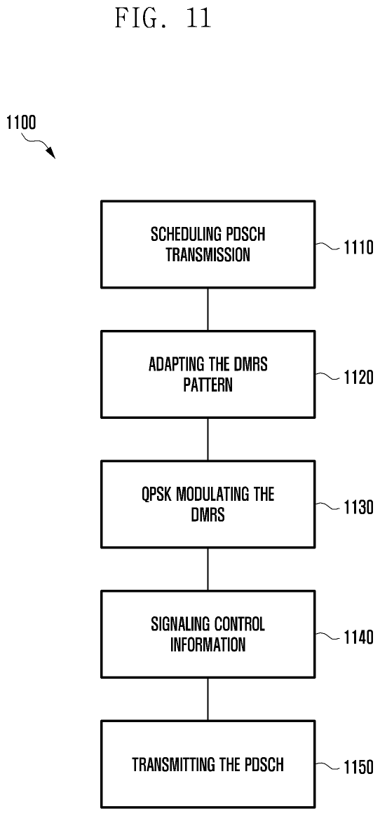

Then, an embodiment of the wireless communication method 1100 according to the disclosure is described with reference to FIG. 11.

FIG. 11 is a flowchart of an embodiment of the wireless communication method according to an embodiment of the disclosure.

Referring to FIG. 11, a method 1100 is performed in a base station (e.g., the TRP 602 of FIG. 6) which supports simultaneous transmission of N spatial MIMO layers of the PDSCH (i.e., 64), each having a different DMRS signal associated therewith.

In operation 1110, transmission of the PDSCH is scheduled to one or more UEs (e.g., the UE 601 of FIG. 6) by using a desired number of M MIMO layers from the N MIMO layers, where M is a positive integer less than N (i.e., M=16 or 8).

In operation 1120, respective adaptation of the DMRS pattern initially defined for N MIMO patterns (see operation 910 with reference to FIG. 9) is performed. As reported above, said initial DMRS pattern is characterized by using L CDM groups (L=4), DFT FD-OCCs of length K_{f}, and DFT TD-OCCs of length Kₜ. For the considered embodiment of N=64, this initial DMRS pattern is illustrated in FIG. 7, where K_{f}=4 and Kₜ=4.

The DMRS pattern is adapted in operation 1120 by reducing the DFT FD-OCC length K_{f} to K_{f}′ and/or reducing the DFT TD-OCC length Kₜ to Kₜ′, where K_{f}′ is a positive integer less than K_{f}, and Kₜ′ is a positive integer less than Kₜ; wherein L may be set equal to 2 or 4. The adapted DMRS pattern provides multiplexing of the M DMRS signals for the M MIMO layers.

For the case illustrated in FIG. 10 (M=16), L remains equal to 4, K_{f}′=2, and Kₜ′=2. For the case illustrated in FIG. 2A (M=8), L is set equal to 2, K_{f}′=2, and Kₜ′=2.

In operation 1140, similarly to operation 940, the TRP sends control information to the UEs. The control information comprises information about the DMRS pattern adapted in operation 1120, including at least the parameters L, K_{f}′, and Kₜ′.

In operation 1150, similarly to operation 950, the scheduled PDSCH transmission is performed.

Another embodiment of adaptation of the DMRS pattern according to the disclosure is based on excluding specific DFT FD-OCCs and/or specific DFT TD-OCCs from respective available DFT OCCs, in a required number and without modifying their length.

The considered other embodiment of the adaptation, like the one considered earlier, is aimed at modifying respective density of DMRS signals in order to improve quality of channel estimation at the receiving side.

Generally speaking, there is the DMRS pattern according to the disclosure, with the available set of K_{f} DFT FD-OCCs and set of Kₜ DFT TD-OCCs. For the DMRS pattern illustrated in FIG. 7, the available FD-OCC sets are presented in Tables 1 and 2, respectively (K_{f}=4, Kₜ=4). The considered approach is generally underlain by such exclusion of orthogonal cover codes from the available set of K_{f} DFT FD-OCCs and/or the available set of Kₜ DFT TD-OCCs, i.e., such creation of a respective reduced subset thereof, that the reduced subset includes DFT OCCs for which a distance between code indices modulo the code length is maximum. This maximization in turn enables to improve efficiency of channel estimation at the receiving side, and this will be discussed hereinbelow in more detail.

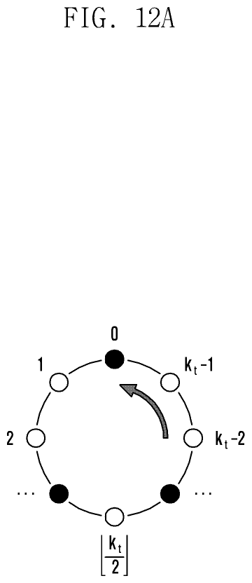

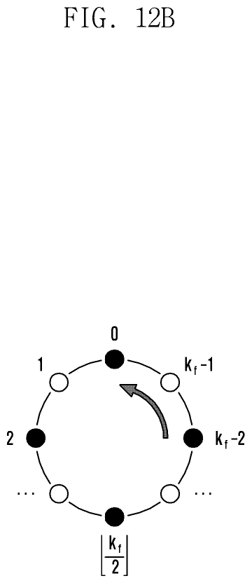

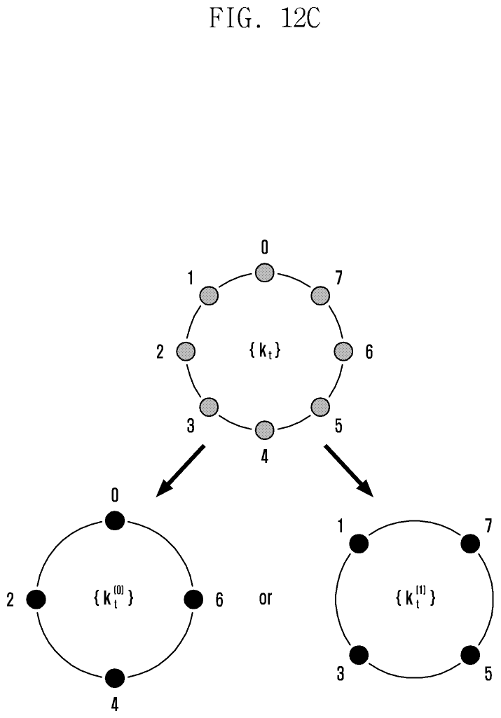

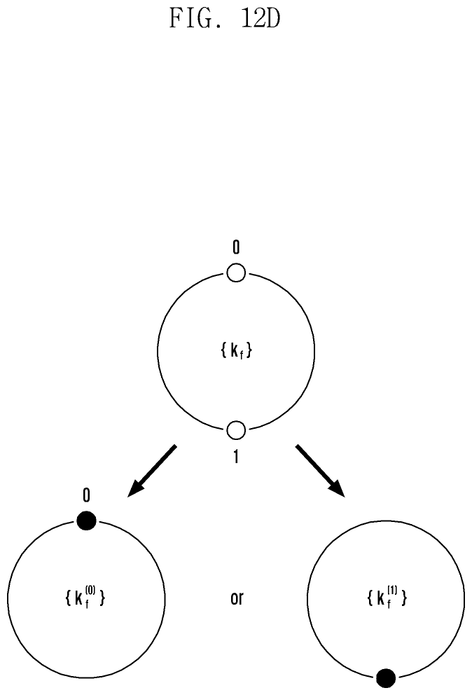

The approach according to the disclosure to the considered embodiment of the adaptation is generally illustrated in FIGS. 12A to 12D: FIGS. 12A and 12C—for DFT TD-OCCs and FIGS. 12B and 12D—for DFT FD-OCCs.

FIGS. 12A, 12B, 12C, and 12D are illustrative embodiments of adaptation according to various embodiments of the disclosure.

Referring to FIGS. 12A and 12B, the available DFT OCC sets are shown, for visual clarity, on a circumference, with indexing the orthogonal cover codes counter-clockwise. Though 8 DFT OCCs are shown in each of them, it should be appreciated that the available set may comprise a different number of DFT OCCs, which is implied by ellipses in those figures.

The reduced subset of DFT FD-OCCs is determined according to the following expression:

$$\{ {k}_{t}^{( m )} \} = mod \{ ⌊ \frac{{K}_{t}}{{K}_{t \_ reduced}} ⌋ \cdot i + m , {K}_{t} \} \qquad Equation 3$$

where
K_{t_reduced} is the required number of orthogonal cover codes in the subset, i.e., after the sub-sampling;
Kₜ is the DFT TD-OCC length;

$$m = 0 , 1 , … , ⌊ \frac{{K}_{t}}{{K}_{t \_ reduced}} ⌋ - 1$$

is the DFT TD-OCC subset index;
i=0, 1, . . . , K_{t_reduced}−1 is the DFT TD-OCC index within the reduced subset;
└ ┘ is the operation of rounding to the closest smaller integer;
mod{a, b} (or b·mod(a)) is the operation of taking the remainder of division of b by a;
kₜ is the DFT TD-OCC code sequence (code vector) index in the initially available set of DFT TD-OCCs (see, for example, Table 2).

The black circles in FIG. 12A illustratively denote the DFT TD-OCCs which the reduced subset is comprised of.

Moreover, FIG. 12C specifically illustrates the possible options of reducing the initially available set of 8 DFT TD-OCCs, which corresponds to the DMRS pattern in FIG. 8, to the subset of 4 DFT TD-OCCs according to the disclosure. As seen from this figure, the subset 0 of 4 DFT TD-OCCs with indices kₜ {0,2,4,6} and the subset 1 of 4 DFT TD-OCCs with indices kₜ {1,3,5,7} may be obtained according to Equation 3.

Then, the reduced subset of DFT FD-OCCs is determined in a similar way according to the following expression:

$$\{ {k}_{f}^{( m )} \} = mod \{ ⌊ \frac{{K}_{f}}{{K}_{f \_ reduced}} ⌋ \cdot i + m , {K}_{f} \} \qquad Equation 4$$

where
K_{f_reduced} is the required number of orthogonal cover codes in the reduced subset;
K_{f} is the DFT FD-OCC length;

$$m = 0 , 1 , … , ⌊ \frac{{K}_{f}}{{K}_{f \_ reduced}} ⌋ - 1$$

is the DFT FD-OCC subset index;
i=0, 1, . . . , K_{f_reduced}−1 is the DFT FD-OCC index within the reduced subset;
k_{f} is the DFT FD-OCC code sequence index in the initially available set of DFT FD-OCCs (see, for example, Table 1).

The black circles in FIG. 12B also illustratively denote the DFT FD-OCCs which the reduced subset is comprised of. Furthermore, FIG. 12D shows, purely for illustration purposes, the possible options of reducing the available set of 2 DFT FD-OCCs to 1 DFT FD-OCC according to the application.

The maximum ‘distance’ between DFT OCCs remaining in the reduced subset is seen from the circumferences of FIGS. 12A to 12C. It should be appreciated that the configuration of the three DFT TD-OCCs of the reduced subset, as illustratively shown in FIG. 12A, is not the only possible implementation, and subsets of the same size may be obtained from other code sequences kₜ, with the same characteristic of ‘distance’. In the same way, the configuration of the four DFT FD-OCCs of the reduced subset, as illustratively shown in FIG. 12B, is not the only possible implementation, and a subset(s) of the same size may be obtained from other code sequences k_{f}, with the same characteristic of ‘distance’. Such possible implementations of one configuration are depicted in FIG. 12C.

Table 3 below provides different configurations of reduced subsets of orthogonal cover codes for the DMRS pattern according to the disclosure, as illustrated in FIG. 7 and in Tables 1, 2.

TABLE 3

| configu- | | | DMRS | |
|---|---|---|---|---|
| ration | k_{f} | kₜ | capacity | remarks |
| 0 | {0, 1, 2, 3} | {0, 1, 2, 3} | 64 | codes are not excluded |
| 1 | {0, 2} or | {0, 1, 2, 3} | 32 | exclusion of codes |
| | {1, 3} | | | for FD-OCCs |
| 2 | {0, 1, 2, 3} | {0, 2} or | 32 | exclusion of codes |
| | | {1, 3} | | for TD-OCCs |
| 3 | {0, 2} or | {0, 2} or | 16 | exclusion of codes |
| | {1, 3} | {1, 3} | | for FD-OCCs and |
| | | | | TD-OCCs |

In accordance with the aforesaid, DMRS capacity in Table 3 refers to the required number of used DMRS ports.

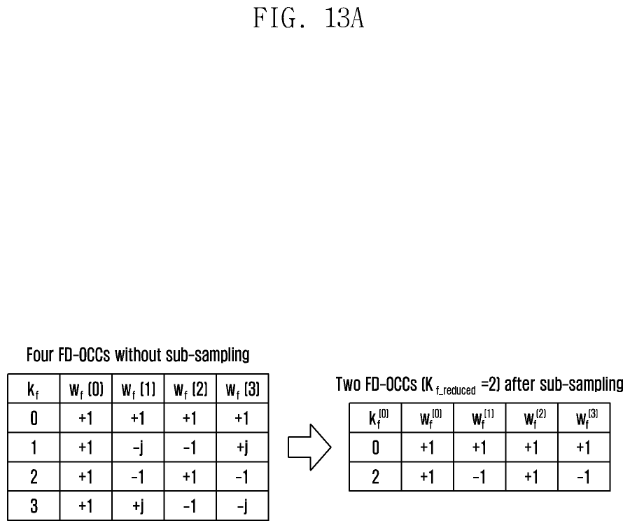

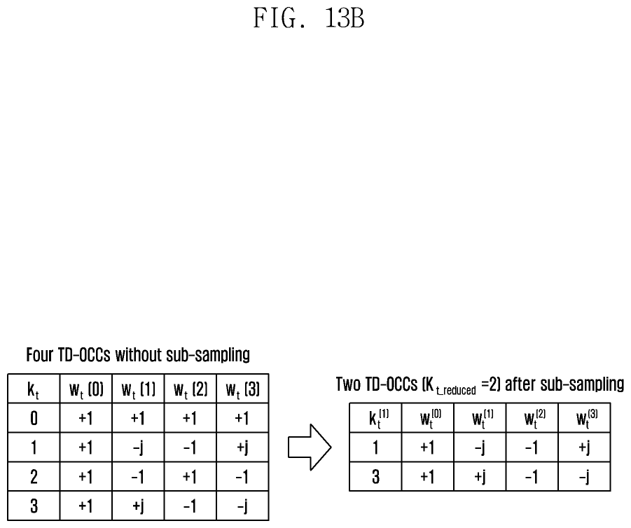

Selection of a reduced DFT OCC configuration from a respective initially available combination of orthogonal cover codes is illustrated in FIGS. 13A and 13B.

FIG. 13A shows generating the reduced subset 0 which consists of the DFT FD-OCC having index 0 and the DFT FD-OCC having index 2 according to an embodiment of the disclosure, which corresponds to the configuration 1 or 3 of Table 3.

FIG. 13B shows generating the reduced subset 1 which consists of the DFT TD-OCC having index 1 and the DFT TD-OCC having index 3 according to an embodiment of the disclosure, which corresponds to the configuration 2 or 3 according to Table 3.

It should be emphasized herein that the required orthogonality is maintained in each of the considered possible embodiments of reduced DFT OCC sets.

Referring to FIGS. 13A and 13B, the DMRS pattern adaptation, as described above, provides an additional advantage at the receiving side, since the approach according to the disclosure to generating reduced code points to reduce DMRS capacity provides more reliable avoidance of interference between DMRS signals, especially in view of various kinds of distortions which the transmitted MIMO layers may be subjected to during propagation; this in turn results in more reliable channel estimation performance at the receiving side.

It should be explained herein that, when using orthogonal cover codes (OCCs) in the DMRS pattern, the procedure of de-spreading the received DMRS sequence should be conducted at the receiver side on the entire length of a respective orthogonal cover code (e.g., on length 4, which corresponds to some embodiments of the disclosure), in order to suppress interference between the orthogonal cover codes. The procedure of generating a reduced OCC set with maximization of the inter-code distance, as discussed above with reference to FIGS. 12A to 12D, 13A, and 13B, provides full suppression of interference by de-spreading the received DMRS sequence on a smaller length (e.g., on length 2). This allows to minimize the influence of possible loss of orthogonality between codes in scenarios with substantial frequency-selective or temporal channel fadings.

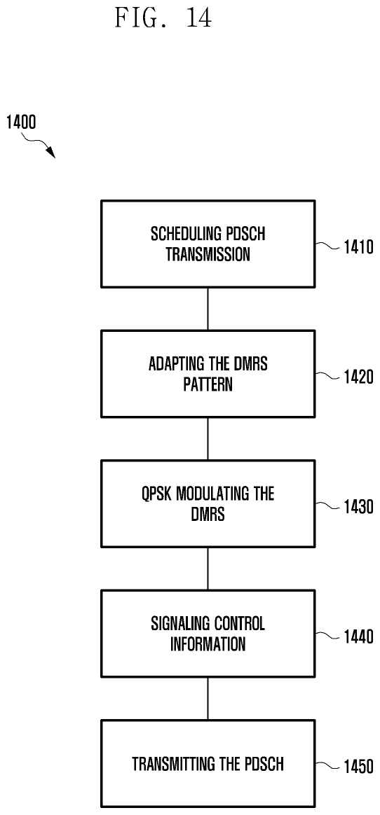

Another embodiment of the wireless communication method 1400 according to the disclosure is described with reference to FIG. 14.

FIG. 14 is a flowchart of another embodiment of the wireless communication method according to an embodiment of the disclosure.

Referring to FIG. 14, a method 1400 is performed in the base station (e.g., the TRP 602 of FIG. 6) which supports simultaneous transmission of N spatial MIMO layers of the PDSCH (i.e., 64) each having a different DMRS signal associated therewith.

In operation 1410, PDSCH transmission to at least one UE (e.g., the UE 601 of FIG. 6) is scheduled by using a desired number M MIMO layers from the N MIMO layers, where M is a positive integer less than N (e.g., M=32, 16, or 8).

In operation 1420, respective adaptation of the DMRS pattern initially defined for the N MIMO layers (see operation 910 with reference to FIG. 9) is performed. As reported above, said initial DMRS pattern is characterized by using L CDM groups (L=4), DFT FD-OCCs of length K_{f}, and DFT TD-OCCs of length Kₜ. For the considered embodiment of N=64, this initial DMRS pattern is illustrated in FIG. 7, where K_{f}=4 and Kₜ=4.

The DMRS pattern is adapted in operation 1420 by reducing the K_{f} initially available DFT FD-OCCs to a reduced subset of K_{f_reduced} DFT FD-OCCs and/or the Kₜ initially available DFT TD-OCCs to a reduced subset of K_{t_reduced} DFT TD-OCCs, where K_{f_reduced} is a positive integer less than K_{f}, and K_{t_reduced} is a positive integer less than Kₜ; wherein L may be set equal to 2 or 4. The adapted DMRS pattern provides multiplexing of the M DMRS signals for the M MIMO layers. Said reduction is performed in such a way that a respective reduced subset includes DFT OCCs for which the distance between code indices modulo the code length is maximum, as disclosed above with reference to FIGS. 12A to 12D, 13A, and 13B, and Table 3.

In operation 1440, similarly to operation 940, the TRP signals control information to the UEs. The control information, besides the parameters L, K_{f}, and Kₜ, also comprises an indication of the reduced DFT FD-OCC subset and/or the reduced DFT TD-OCC subset. The aspects of signaling the control information, including the indication of an orthogonal cover code set(s), will be disclosed hereinbelow.

In operation 1450, similarly to operation 950, the scheduled PDSCH transmission is performed.

The attention should be drawn to the fact that, in any of the embodiments of adaptation described above, the DMRS pattern according to the disclosure remains stable and maintains uniformity in the frequency domain. That is, the disclosure avoids transitioning to a substantially different DMRS pattern when it is required to change DMRS capacity, like e.g. in the case of switching between Type 1 and Type 2 in 5G NR, and the associated growth of complexity of the channel estimation algorithm at the receiving side.

According to the disclosure, combined usage of both disclosed options of adapting the DMRS pattern is not excluded. For instance, the DMRS pattern shown in FIG. 8 may be adapted to the DMRS pattern shown in FIG. 7 by accordingly reducing the DFT TD-OCC length, as outlined above, and thereafter this adapted DMRS pattern may be subjected to further adaptation by excluding orthogonal cover codes in accordance with the disclosure of FIGS. 12A to 12D, 13A, and 13B with reference to Table 3.

Though the abovementioned adaptation methods according to the disclosure have been described for the case of reducing DMRS capacity, it should be appreciated that they are also applicable to the case of increasing thereof, when it may be required to again transmit a greater number of MIMO layers.

In particular, an embodiment of the wireless communication method 1100, which corresponds to at least partial inversion of said former embodiment of adapting the DMRS pattern, is illustrated with reference to FIG. 11. The method 1100 is performed in a base station (i.e., the TRP 602 of FIG. 6) which supports simultaneous transmission of N spatial MIMO layers of the PDSCH (e.g., 64), each having a different DMRS signal associated therewith. It is implied in the embodiment considered herein that the TRP is currently using the previously adapted DMRS pattern wherein M (M<N) DMRS signals are multiplexed (i.e., the adapted DMRS pattern illustrated in FIG. 10, where M=16).

In operation 1110, another PDSCH transmission is scheduled to at least one UE (i.e., the UE 601 of FIG. 6) by using M′ MIMO layers, where M<M′≤N.

In operation 1120, adaptation of the DMRS pattern is performed by respectively increasing the DFT FD-OCC length K_{f}′ to K_{f}″, where K_{f}′<K_{f}″≤K_{f}, and/or increasing the DFT TD-OCC length Kₜ′ to Kₜ′″, where Kₜ′<Kₜ″≤Kₜ (see Equations 1, and 2). The adapted DMRS pattern provides multiplexing of the M′ DMRS signals for the M′ MIMO layers. For the embodiment of M′=N=64 considered herein, the DMRS pattern obtained in operation 1120 is illustrated in FIG. 7, where K_{f}″=K_{f}=4 and Kₜ″=Kₜ=4 at L=4.

In operation 1140, the TRP sends control information to the UE. The control information contains information about the DMRS pattern obtained in operation 1120, including at least the parameters L, K_{f}″, and Kₜ″.

In operation 1150, the scheduled another PDSCH transmission is performed.

For the case of inverting said latter embodiment of adapting the DMRS pattern, the base station uses a new, increased value of the number of OCCs, for example, K_{t_reduced}=Kₜ (see Equation 3) and/or K_{f_reduced}=K_{f} (see Equation 4), and signals this new value(s) to the UEs.

To summarize the aforesaid, the DMRS pattern according to the disclosure, on one hand, enables to multiplex a greater number of DMRS signals, as corresponding to the requirements of next generation wireless communication systems (i.e., 64 in the case of the 6G 10-12 GHz frequency range), and, on the other hand, has flexible, dynamic (unlike the semi-static one in 5G NR) adaptability, without substantial modification of the DMRS pattern itself (i.e., the DMRS pattern provided herein is unified) and with maintenance of the desired quality and low complexity of channel estimation at the receiving side, as well as with support of backwards compatibility.

Then, as recited plural times earlier, DMRS signals transmitted from one base station are orthogonal, i.e., they do not cause interference to each other within a cell covered by said base station. For example, if the scheme of FIG. 6 is referred to, DMRS signals transmitted from the TRP 602-B do not cause interference in each of the UE 601-1, the UE 601-2, the UE 601-3 which are in the cell covered by the TRP 602-B; DMRS signals transmitted from the TRP 602-C do not cause interference in each of the UE 601-4, the UE 601-5, the UE 601-6, the UE 601-7 which are in the cell covered by the TRP 602-C. At the same time, orthogonality between DMRS signals of neighboring cells is initially not ensured, which may cause interference at cell boundaries. As seen from FIG. 6, the UE 601-3 is simultaneously within coverage areas of the base stations TRP 602-A and TRP 602-B and is in close proximity to the boundary of the cell covered by the base station TRP 602-C. Therefore, interference between DMRS signals received simultaneously from the TRP 602-A, the TRP 602-B, the TRP 602-C may occur in the UE 601-3. Said possible non-orthogonality may lead to highly undesirable decrease of channel estimation quality in the UE 601-3.

As in the case of the known wireless communication systems which have been discussed above, in the disclosure, in order to mitigate this problem, DMRS signals transmitted from each of the TRPs are subjected to QPSK modulation to provide inter-TRP randomization of DMRS signals and thereby avoid interference therebetween. As in the case of said known systems (in particular, 5G NR), according to the disclosure a sequence of QPSK-symbols for modulating the DMRS pattern is obtained from pseudo-nose (PN) sequences. More specifically, the PN sequences represent Gold sequences of length 31. Initialization of the PN sequences is individually configurable per base station. An initialization parameter (seed) of a PN sequence is denoted in the application as N_{ID}.

Initialization of PN sequences according to the disclosure is illustrated below in Table 4 for the case of using the unified DMRS pattern provided herein (see, for example, FIG. 7).

TABLE 4

| | n_{SCID} = 0 | n_{SCID} = 1 | n_{SCID} = 2 | n_{SCID} = 3 |
|---|---|---|---|---|
| Δ = 0 | N_{ID}⁰ | N_{ID}¹ | N_{ID}² | N_{ID}³ |
| Δ = 1 | N_{ID}¹ | N_{ID}⁰ | N_{ID}³ | N_{ID}² |
| Δ = 2 | N_{ID}² | N_{ID}³ | N_{ID}⁰ | N_{ID}¹ |
| Δ = 3 | N_{ID}³ | N_{ID}² | N_{ID}¹ | N_{ID}⁰ |

In accordance with the disclosure, a plurality of sets of initialization parameters {N_{ID}ⁱ} is provided. For Table 4, such sets correspond to its columns. Each initialization parameter in each of the sets is defined independently for each of the L CDM groups, i.e., in general i=0, . . . , L−1; specifically for the case according to FIG. 7 and Table 4, i=0, 1, 2, 3. Then, a unique parameter—a scrambling parameter n_{SCID}—is associated with each of the initialization parameter sets, the scrambling parameter substantially uniquely identifying the respective initialization parameter set. Initialization parameter sets identified by any different n_{SCID}'S are element-wise different. The sequential order of initialization parameters {N_{ID}ⁱ}, i=0, 1, 2, 3, in the initialization parameter sets respectively identified by the four scrambling parameters n_{SCID} is specifically illustrated in Table 4. Moreover, the cells highlighted in Table 4 by a more solid line relate to the embodiment of the pattern with two CDM groups (i.e., L=2, Δ=0, 1, i=0, 1), which corresponds to the 5G NR DMRS patterns described above, as well as to the abovementioned adapted DMRS patterns according to the disclosure. Each of the neighboring base stations is assigned with its own different n_{SCID}, i.e., its own different initialization parameter set.

For the purpose of explanation of the aforesaid with reference to Table 4, for the initialization parameter set identified by n_{SCID} equal to 0, signals of the CDM group with index Δ=0 are modulated by the PN sequence initialized by N_{ID}⁰, signals of the CDM group with index Δ=1 are modulated by the PN sequence initialized by initialized by N_{ID}¹, signals of the CDM group with index Δ=2 are modulated by the PN sequence initialized by N_{ID}², and signals of the CDM group with index Δ=3 are modulated by the PN sequence initialized by N_{ID}³. A similar scenario will take place in the case of n_{SCID} equal to 1, 2, or 3 as well.

The usage of scrambling parameters which unambiguously identify respective different sets of initialization parameters of PN sequences enables to promptly, dynamically notify user devices on which initialization parameters shall be used for QPSK demodulation of received signals. Said notifying is preferably performed by the DCI transmitted in the PDCCH. For instance, inclusion into the DCI transmitted from a TRP (e.g., the TRP 602-B of FIG. 6) of n_{SCID} equal to 1 instructs all UEs currently served by said TRP to use the initialization parameter set {N_{ID}¹, N_{ID}⁰, N_{ID}³, N_{ID}²} for the CDM groups Δ=0, 1, 2, 3, respectively. It should be noted that the usage of one parameter n_{SCID} enables to avoid excessive bit overhead in the DCI. Furthermore, fast (i.e., with low delays) switching of an initialization parameter set at the UE side is provided thereby. Following the above example, if a UE (i.e., the UE 601-3 of FIG. 6) subsequently receives, from a TRP (e.g., the TRP 602-A of FIG. 6), the DCI with a different scrambling parameter, for example, n_{SCID} equal to 3, then prompt switching to the respective initialization parameter set {N_{ID}³, N_{ID}², N_{ID}¹, N_{ID}⁰} will be ensured in the UE 601-3. It should be noticed that the example of switching initialization parameters of PN sequences, as presented herein, has solely illustrative nature.

It should be emphasized herein that, owing to usage of the C-RAN technology, which has been discussed above, in existing and future wireless communication systems, fast switching of a UE between base stations is provided, in particular. Therefore, the necessity further arises in respective prompt switching between initialization parameter sets. The technical solution described herein enables to ensure the required promptness.

Therefore, each of the methods 900, 1100, 1400 described above with reference to FIGS. 9, 10, 11, and 14 is added, preferably prior to operations 940, 1140, 1440 of sending the control information, with operations 930, 1130, 1430 wherein modulation of DMRSs is performed with a sequence of QPSK-symbols which are obtained from PN sequences each initialized by a different initialization parameter N_{ID} from a set comprising L initialization parameters, wherein a different scrambling parameter n_{SCID} is associated with each of the L initialization parameter sets, wherein, in each of the L initialization parameter sets, each of L initialization parameters is set different for each of L CDM groups, so that, for each of the L CDM groups, initialization parameters are different for different scrambling parameters (see Table 4 for illustration). Moreover, the control information for scheduling PDSCH or PUSCH transmissions, which is respectively transmitted in operations 940, 1140, 1440 preferably via the DCI to each of UEs served by the base station, further comprises a current value of the scrambling parameter n_{SCID} used for said modulation, in order to instruct the UE to use the initialization parameter set identified by said value.

As reported above, a similar procedure is also applied in uplink to randomize interference between DMRS signals from UEs served by neighboring TRPs.

The approaches to multiplexing DMRS signals according to the disclosure, as disclosed above with reference to FIGS. 7, 8, 9, 10, 11, 12A to 12D, 13A, 13B, and 14, are summarized by the following mathematical expression which defines the DMRS signal value a for DMRS port p in subcarrier k and OFDM-symbol 1:

$${α}_{k , l}^{( p )} = {β}^{DRMS} {w}_{t} ( {l}^{′} ) {w}_{f} ( {k}^{′} ) r ( 2 n + {k}^{′} ) \qquad Equation 5$$

wherein
β^{DMRS} is the power offset for the DMRS;

$${w}_{f} ( {k}^{′} ) = \{ {e}^{- 2 π j \frac{{k}_{f}}{{K}_{f}} {k}^{′}} \} , {k}^{′} = 0 , … , {K}_{f} - 1 \qquad Equation 5 - 1$$

w_{f}(k′) is the DFT FD-OCC (see Equation (1) and explanations with respect thereto), where k_{f} is the DFT FD-OCC code vector index, K_{f} is the DFT FD-OCC length, k′ is the DMRS subcarrier index in a CDM group (for the DMRS pattern according to the disclosure, as shown in FIG. 7, see Table 1: K_{f}=4, k′=0, 1, 2, 3, k_{f}=0, 1, 2, 3);

$${w}_{t} ( {l}^{′} ) = \{ {e}^{- 2 π j \frac{{k}_{t}}{{K}_{t}} {l}^{′}} \} , {l}^{′} = 0 , … , {K}_{t} - 1 \qquad Equation 5 - 2$$

wₜ(l′) is the DFT TD-OCC (see Equation (2) and explanations with respect thereto), where kₜ is the DFT TD-OCC code vector index, Kₜ is the DFT TD-OCC length, l′ is the DMRS OFDM-symbol index in a CDM-group (for the DMRS pattern according to the disclosure, as shown in FIG. 7, see Table 2: Kₜ=4, l′=0, 1, 2, 3, kₜ=0, 1, 2, 3);

$$k = {K}_{f} \cdot L \cdot n + L \cdot {k}^{′} + Δ \qquad Equation 5 - 3$$

k is the subcarrier index, where Δ is the CDM group index, L is the number of CDM groups (for the DMRS pattern according to the disclosure, as shown in FIG. 7, L=4, K_{f}·L=16);

$$l = {T}_{DRMS} \overline{l} + {l}_{start}^{PDSCH} + {l}^{′} \qquad Equation 5 - 4$$

l is the OFDM-symbol index, where lₛₜₐᵣₜ^{PDSCH} is the start OFDM-symbol index of a PDSCH time interval bundle within a DL/UL-period, l̅—is the DMRS occasion index within the DL/UL-period, l̅=0, 1, 2, . . . , T_{DMRS} is the DMRS period. DL/UL-periods, as well as the parameters lₛₜₐᵣₜ^{PDSCH}, l̅, T_{DMRS}, will be discussed in more detail in subsequent sections of the description of the disclosure;

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) , n = 0 , 1 , 2 , … \qquad Equation 5 - 5$$

r(n) is the QPSK sequence, where c( . . . ) is the Gold sequence of length 31 which is unique for each CDM group and which is respectively initialized for the each CDM group by its own cᵢₙᵢₜ. For the embodiment discussed above with reference to Table 4,

$${c}_{init} = ( {2}^{18} ( {N}_{symb}^{UL - DL} \cdot {n}_{UL - DL}^{f} + l + 1 ) ( 4 {N}_{ID}^{{n}_{SCID}} + l + 1 ) + 4 {N}_{ID}^{{n}_{SCID}} \qquad Equation 5 - 6$$

where
n_{SCID} is the scrambling parameter (in accordance with the aforesaid with reference to Table 4, it may be dynamically indicated in the DCI among the values {00, 01, 10, 11}),
N_{ID} is the initialization parameter (see Table 4, wherein N_{ID}⁰, N_{ID}¹, N_{ID}², N_{ID}³∈{0, 1, . . . , 65535})
N_{symb}^{UL-DL} is the number of OFDM-symbols within the DL/UL-period,
n_{UL-DL}^{f} is the DL/UL-period index.

### II. Indication of DMRS Ports for UEs

In view of the aforesaid when describing the background art, the following problem exists in the context of designing next generation (including 6G) wireless communication systems.

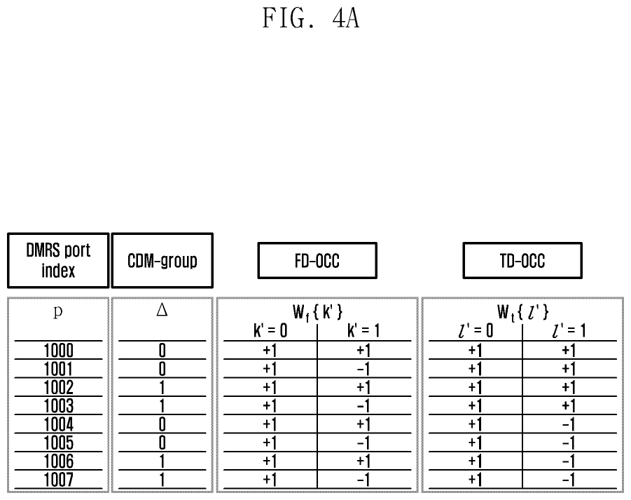

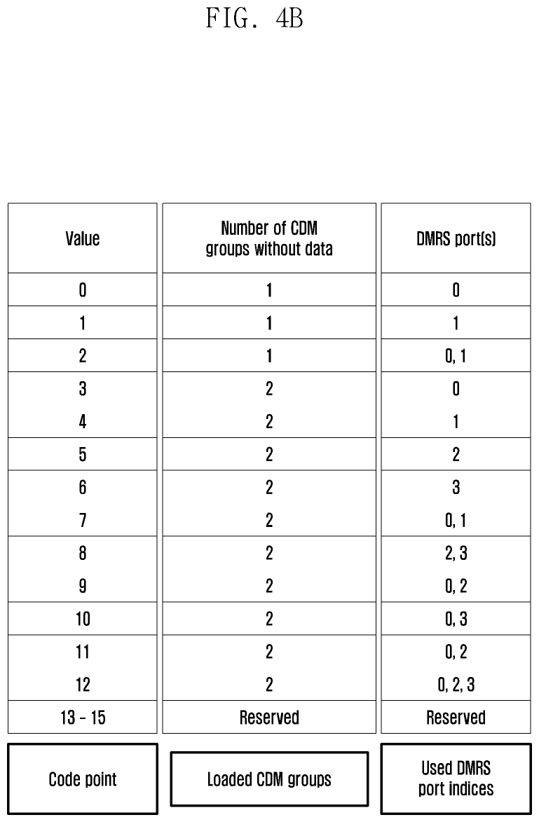

On one hand, it is required to increase capacity of the DMRS pattern in view of a significantly greater supported number of spatial MIMO layers for broadband data transmission. At the same time, the DMRS port indication scheme existing in 5G NR, as briefly described with reference to FIGS. 4A and 4B, supports at most 12 DMRS ports at the TRP side and at most 8 DMRS ports per UE (SU-MIMO), at the absence at present time of a systematized approach enabling to extend said existing scheme to the required greater number of DMRS ports—in particular, 64 DMRS ports at the TRP side and 16 at the UE side.

On the other hand, the information about DMRSs, inter alia about DMRS ports to be used, should be signaled to user devices with a small delay, and transmission of the DCI over the PDCCH is typically used to this end; moreover, there is a strict constraint on the total number of DCI bits, as reported above. As a consequence, an attempt to directly extrapolate the existing scheme or approaches similar thereto onto next generation wireless communication systems for transmission to UEs of the information about DMRS ports, which are to be used, over the physical control channel will lead to the unacceptably great number of bits in the DCI.

In the application the techniques are provided in the considered context which enable to efficiently encode the control information transmitted from a TRP about a sub-combination of DMRS ports to be used in a UE(s), with relatively low bit overhead in the control information.

### Embodiment 1: Tree-Based Indication of DMRS Ports with Prefix Coding

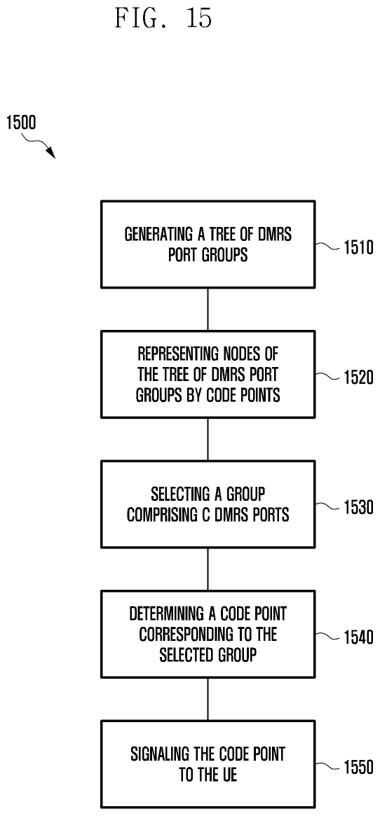

The tree-like hierarchy based implementation of DMRS port indication with prefix coding according to the application is described thereafter with reference to FIGS. 15, 16A, 16B, and 17. First of all, an embodiment of the method 1500 of indicating DMRS ports for at least one UE in a wireless communication is described with reference to FIG. 15 according to the general approach corresponding to this embodiment. The method 1500 is performed in a base station (e.g., the TRP 602 of FIG. 6) which supports simultaneous transmission of N spatial MIMO layers of the PDSCH (i.e., 64) each having a different DMRS signal associated therewith.

FIG. 15 is a flowchart of the method of indicating DMRS ports for a UE according to an embodiment of the disclosure.

Referring to FIG. 15, in a method 1500, in operation 1510, a tree-like hierarchy of DMRS port groups is generated, where every hierarchy node corresponds to a group of one or more DMRS ports. In particular, every node in the lowest (leaf) tier of the hierarchy corresponds to one of a preset number N′ of DMRS ports. Preferably, N′=N, i.e., the total number of DMRS ports available for usage in the TRP. In every subsequent tier of the tree-like hierarchy, counting from its leaf tier, every node corresponds to a DMRS port group obtained by merging the same number of different DMRS port groups from a preceding hierarchy tier. The highest (sub-root) tier of the tree of DMRS port groups is the tier where the number of DMRS ports in every DMRS port group is equal to the total number M of DMRS ports available for being used in the UE (i.e., 16), where M≤N′.

In operation 1520, every node of the generated tree of DMRS port groups is represented by a code point. Every code point is comprised of a first subset of bits and a second subset of bits, wherein a number of bits in the first subset and a number of bits in the second subset are variable. For every node of the hierarchy of DMRS port groups in a specific hierarchy tier, bits of the first subset encode the number of DMRS ports in every DMRS port group in said specific hierarchy tier, while bits of the second subset encode a DMRS port group corresponding to said hierarchy node.

In operation 1530, a group comprising C DMRS ports to be used in the UE, where C≤M, is selected in the tree-like hierarchy of DMRS port groups.

In operation 1540, a code point corresponding to the selected DMRS port group is determined from the code points obtained in operation 1520.

In operation 1550, control information including the code point determined in operation 1540 is signaled to the UE. This signaling is preferably performed by the DCI transmitted in the PDCCH. The signaling of the code point in operation 1550 may indicate to the UE to use the selected C DMRS ports for reception of C MIMO layers of the PDSCH. Or said signaling may indicate to the UE to use the selected C DMRS ports for transmission of C MIMO layers of the PUSCH.

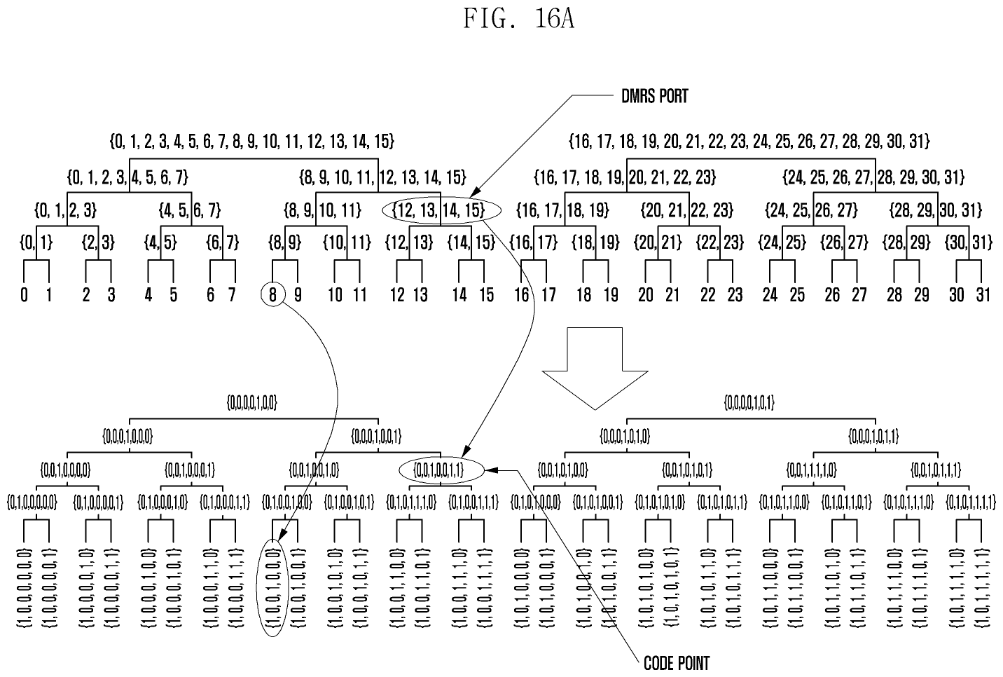

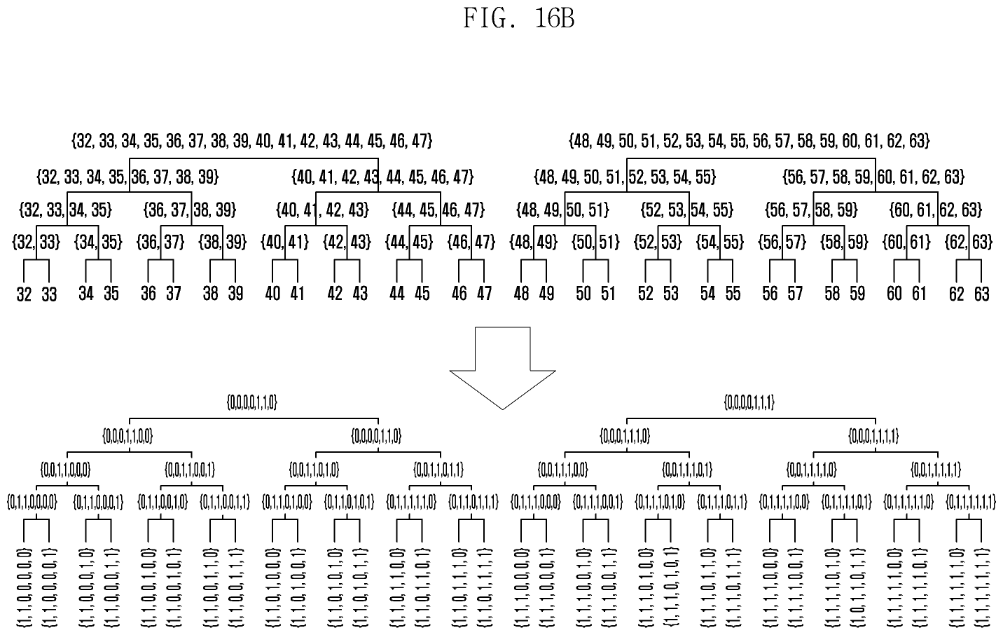

The general approach described above with reference to FIG. 15 is illustrated in FIGS. 16A and 16B by a specific embodiment of pair-wise merging DMRS port groups, wherein N and M are power 2 integers.

FIGS. 16A and 16B show a single tree of DMRS port groups which is obtained for the case where N′=N=64 and M=16 (the upper part of the figures), as well as code points corresponding thereto (the lower part of the figures) according to various embodiments of the disclosure.

Referring to FIGS. 16A and 16B, Indices used in the presented tree-like hierarchy of DMRS port groups correspond to sequential indices of DMRS ports. Every node in the lowest hierarchy tier (a leaf) corresponds to one of 64 DMRS ports available for being used in the TRP. Starting from the leaf tier, every DMRS port group of a subsequent tier of the tree is obtained by merging two adjacent DMRS port groups from a preceding hierarchy tier in such a way that every DMRS port group of the preceding hierarchy tier is included only by one DMRS port group of the subsequent hierarchy tier. In the highest tier of the considered tree, nodes correspond to four combinations of sequential 16 DMRS ports which may be available for usage in the UE.

Then in each of the code points which are illustrated by the lower part of FIGS. 16A and 16B, the second subset of bits is a postfix subset, whereas the first subset of bits is a prefix subset. For every node of the tree-like hierarchy of DMRS port groups in its specific tier, bits of the prefix subset encode the number of DMRS ports in every DMRS port group in this specific hierarchy tier, while bits of the postfix subset encode a specific DMRS port group corresponding to said node. In particular, in accordance with the illustration of FIG. 16A, the DMRS port group {12,13,14,15} is represented by the code point {0,0,1,0,0,1,1} in which the prefix (0,0,1) substantially encodes a tree tier where nodes located in said tree tier each represent groups of 4 DMRS ports, while the postfix (0,0,1,1) encodes the specific group {12,13,14,15} in said tier. Therefore, namely the code point {0,0,1,0,0,1,1} will be signaled in the DCI in operation 1550. In a similar way, in FIG. 16A the tree leaf corresponding to the DMRS port 8 is represented by the code point {1,0,0,1,0,0,0}, wherein the prefix (1) encodes the lowest tier of the tree, whereas the postfix (0,0,1,0,0,0) encodes the particular single port. In this case, the code point {1,0,0,1,0,0,0} will be signaled in the DCI in operation 1550. In both considered illustrative cases, the size of the code point is only 7 bits, i.e., bit overhead in the DCI for indicating the required combination of DMRS ports is low.

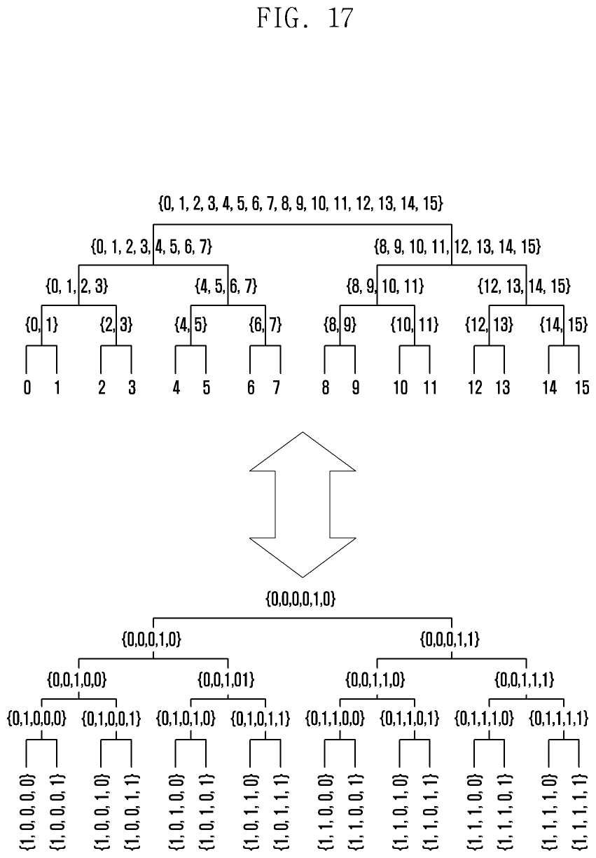

FIG. 17 similarly illustrates adaptation of the considered approach when DMRS port groups are generated from the total number of 16 DMRS ports, i.e., N′=M=16 (the upper part of the figure) according to an embodiment of the disclosure, and are respectively represented by code points (the lower part of the figure).

Referring to FIG. 17, every leaf in the lowest tier of the tree-like hierarchy corresponds to a specific one of the 16 DMRS ports, whereas its highest tier corresponds to the combination of all the sequential 16 DMRS ports. Every code point similarly encodes, by its prefix part, a tree tier, and encodes, by its postfix part, a specific DMRS port group. In the illustrative case considered herein, the code point size is 5 bits, i.e., bit overhead in the DCI for indicating the required combination of DMRS ports is again very low.

It should be appreciated that the bit representation outlined in FIGS. 16A, 16B, and 17 and respective disclosure is illustrative, but not the only possible. In particular, without limitation of generality, in every code point, its postfix subset may encode a tier of the tree of DMRS groups, while the prefix subset may encode a specific DMRS group from this tier; moreover or in addition to this, other combinations of bits for the encoding may be used in one of or both the postfix subset and the prefix subset—in particular, values of bits in one of or both the postfix subset and the prefix subset may be respectively inverted: 0→1, 1→0.

The advantages of the considered embodiment 1 refer to very low DCI bit overhead and good scalability. Its principal drawback is low flexibility, since only a relatively small number of strictly defined combinations of DMRS ports may be indicated for usage.

### Embodiment 2: Indicating Adjacent DMRS Ports

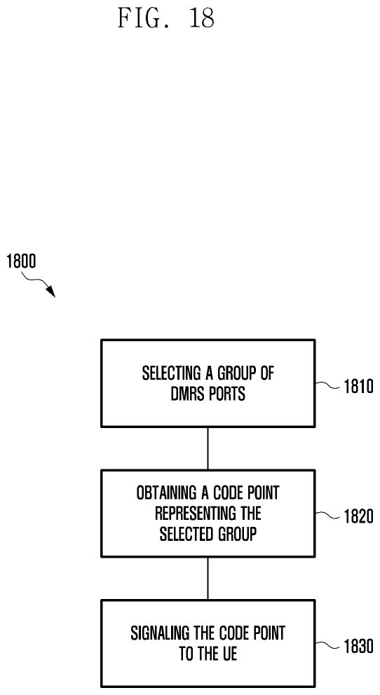

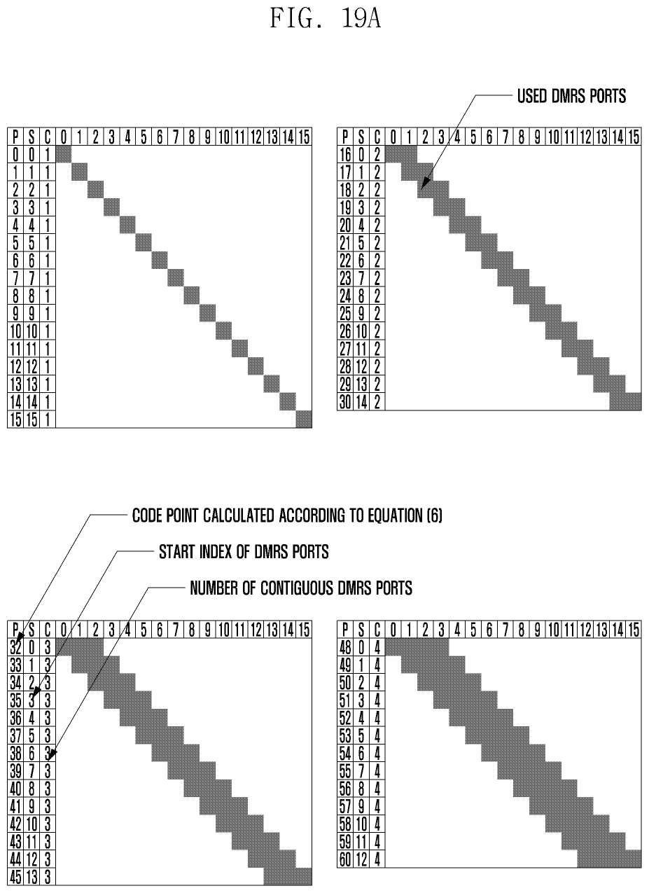

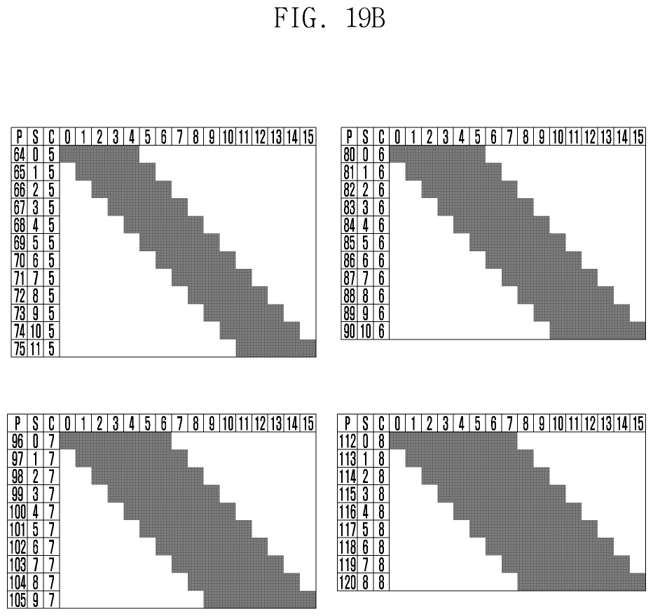

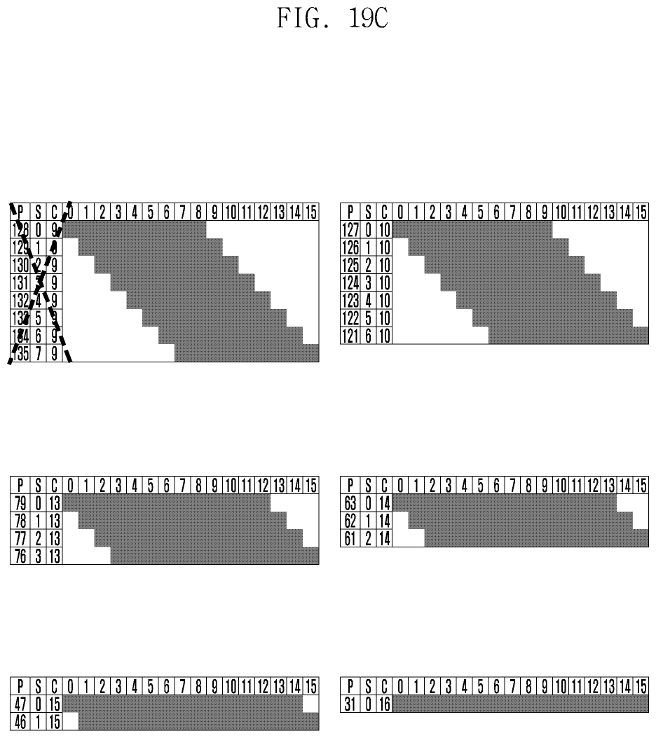

The implementation of indicating adjacent DMRS ports based on one-to-one coding (mapping) according to the application is described hereinafter with reference to FIGS. 18, 19A, and 19B. First of all, an embodiment of the method 1800 of indicating DMRS ports for at least one UE in a wireless communication system according to the general approach corresponding to this embodiment is described with reference to FIG. 18.

FIG. 18 is a flowchart of the method of indicating DMRS ports for a UE according to an embodiment of the disclosure.

Referring to FIG. 18, a method 1800 is performed in a base station (i.e., the TRP 602 of FIG. 6) which supports simultaneous transmission of a plurality of PDSCH spatial MIMO layers each having a different DMRS signal associated therewith.

In operation 1810, a DMRS port group comprising C sequential indices of DMRS ports to be used in the UE is selected from the total number M of sequential indices of DMRS ports available for being used in the UE, where C≤M.

In operation 1820, a code point P is obtained which represents the DMRS port group selected in operation 1810. The code point is calculated as follows:

$$if ( C - 1 ) \leq M / 2 \\ P = M \cdot ( C - 1 ) + s , \qquad Equation6$$

$$else$$

$$P = M \cdot ( M - Χ + 1 ) + ( N - 1 - s ) ,$$

where s is the start DMRS port index in the selected DMRS port group, s=0, 1, . . . , C−1.

In operation 1830, control information, which includes binary representation of the code point P obtained in operation 1820, is signaled to the UE. Said signaling is preferably performed through the DCI transmitted in the PDCCH. In the UE, a respective DMRS port group to be used may be obviously restored from the received code point P. Moreover, similarly to embodiment 1, the signaling of the code point in operation 1830 may indicate to the UE to use the selected C DMRS ports for receiving C MIMO layers of the PDSCH, or indicate to the UE to use the selected C DMRS ports for transmitting C MIMO layers of the PUSCH.

If a requirement to limit bit size of the code point P is imposed, then possible values of C may be additionally limited in operation 1810 as 2^{γ}3^{ζ}, where γ and ζ are non-negative integers, for example, C=2, 3, 4, 6, 8, 9, 12, 16.

The general approach, as disclosed above with reference to FIG. 18, is illustrated in FIGS. 19A, 19B, and 19C by the table representation of specific embodiments of generating possible groups of adjacent DMRS ports from the total number M=16 of sequential DMRS port indices.

FIGS. 19A, 19B, and 19C are illustrations of the table representation of adjacent DMRS port groups according to various embodiments of the disclosure.

Referring to FIGS. 19A-19C, by signaling the code point P=72 in operation 1830, the UE is instructed to use the combination of DMRS ports {8,9,10,11,13} (see FIG. 19B).

Striking out the table in FIG. 19C illustrates the abovementioned limitation of values of C in operation 1810 of the method 1800; i.e., C=9 is excluded from usage.

In the illustrative case considered herein, the code point size does not exceed 8 bits, i.e., bit overhead in the DCI to indicate the required combination of DMRS ports is again not high, though it is in general exceeds the one according to embodiment 1.

The advantages of the considered embodiment 2 refer to relatively low DCI bit overhead, good scalability for different numbers of supported DMRS ports, and greater flexibility as compared to embodiment 1, in terms of greater variety of options to select combinations of DMRS ports. Attention should be further drawn to high efficiency of the encoding, as considered herein, in terms of compactness of representation of all the possible groups of adjacent DMRS ports from the total available number thereof by means of the code point defined by Equation 6, without divergences or omissions.

### Embodiment 3: Indicating DMRS Ports Based on Combinatorial Coding

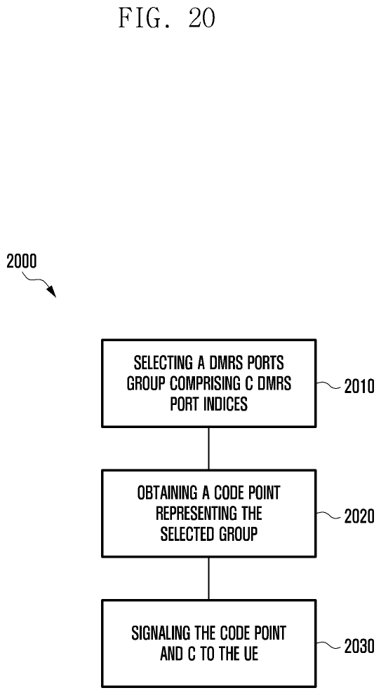

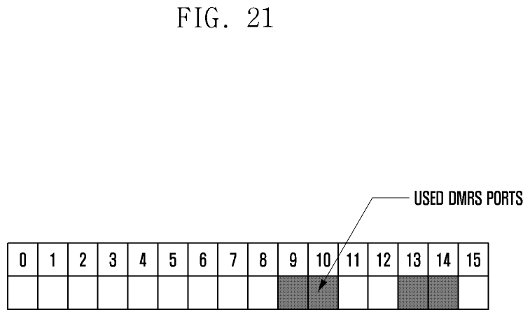

The implementation of indicating generally non-adjacent DMRS ports based on combinatorial coding according to the application is described hereinbelow with reference to FIGS. 20 and 21. First of all, an embodiment of the method 200 of indicating DMRS ports for at least one UE in a wireless communication system according to the general approach of said embodiment is disclosed with reference to FIG. 20.

FIG. 20 is a flowchart of the method of indicating DMRS ports for a UE according to an embodiment of the disclosure.

Referring to FIG. 20, a method 2000 is performed in a base station (e.g., the TRP 602 in FIG. 6) which supports simultaneous transmission of a plurality of PDSCH spatial MIMO layers each having a different DMRS signal associated therewith.

In operation 2010, a DMRS port group comprising C indices of DMRS ports to be used in the UE is selected from the total number M of sequential indices of DMRS ports available for being used in the UE, where C≤M.

In operation 2020, a code point P is obtained which represents the DMRS port group selected in operation 2010. The code point is calculated by combinatorial coding as follows:

$$P = {\sum }_{i = 0}^{C - 1} 〈 \begin{matrix}M - {p}_{i} \\ C - i\end{matrix} 〉 , \qquad Equation7$$

$$where$$

$$〈 \begin{matrix}x \\ y\end{matrix} 〉 = \{ \begin{matrix}( \begin{matrix}x \\ y\end{matrix} ) , x \geq y \\ 0 , x < y\end{matrix} , ( \begin{matrix}x \\ y\end{matrix} ) = \frac{x !}{y ! ( x - y ) !}$$

{pᵢ} is the ordered set of indices pᵢ of the selected group of DMRS ports, i=0, . . . , C−1, pᵢ=1, 2, . . . , M.

In operation 2030, control information, which includes binary representation of the code point P obtained in operation 2020, as well as binary representation of the value of C, is signaled to the UE. The signaling is preferably performed through the DCI transmitted in the PDCCH. Moreover, similarly to embodiments 1 and 2, the signaling of the code point in operation 2030 may indicate to the UE to use the selected C DMRS ports for receiving C MIMO layers of the PDSCH, or indicate to the UE to use the selected C DMRS ports for transmitting C MIMO layers of the PUSCH.

It is supposed for illustration of the general approach disclosed above with reference to FIG. 20 that the following combination of C=4 DMRS ports—{9,10,13,14}—is selected in operation 2010 for being used in the UE where, in total, M=16 DMRS ports are available for usage. Then, by using Equation 7 according to operation 2020, the code point is obtained:

$$P = ( \begin{matrix}16 - 9 \\ 4\end{matrix} ) + ( \begin{matrix}16 - 10 \\ 3\end{matrix} ) + ( \begin{matrix}16 - 13 \\ 2\end{matrix} ) + ( \begin{matrix}16 - 14 \\ 1\end{matrix} ) = 60.$$

This example is illustrated in FIG. 21.

FIG. 21 is an example of encoding a combination of DMRS ports an of the FIG. 20 according to an embodiment of the disclosure.

Referring to FIG. 21, by means of signaling the code point P=60 and C=4 in operation 2030, the UE is instructed to use the non-sequential combination of DMRS ports {9,10,13,14} (see FIG. 21). In the illustrative example considered herein, bit overhead in the DCI is 14 bits.

A number of approaches are known which may be implemented in the UE to restore the combination of DMRS ports to be used from the received control information transmitted from the TRP in operation 2030, first of all—based on the code point obtained by combinatorial coding in accordance with Equation 7.

The basic advantage of the considered embodiment 3 refers to much greater flexibility even in comparison with embodiment 2, since embodiment 3 enables to indicate a substantially arbitrary combination of DMRS ports. The drawback of said embodiment is noticeably greater DCI bit overhead.

Hereinafter, the description is given of a possible application of the above embodiments 1 to 3 to the case when, in a TRP, the number of MIMO layers is reduced and respective adaptation of the DMRS pattern, the embodiments of which have been described in detail in subsection I of the specification with reference to FIGS. 10, 11, 12A to 12D, 13A, 13B, and 14, is performed.

It should be noted herein that, in embodiments 1 to 3 where DMRS port indices are coded for being signaled in the DCI, existence of a table is assumed which characterizes DMRS ports, similar to the one illustrated in FIG. 4A. For instance, when the DMRS pattern according to the disclosure, as illustrated in FIG. 7, is used in the TRP, then such common table will index 64 DMRS ports to each of which its own unique set of a CDM group, a DFT FD-OCC of length 4, and a DFT TD-OCC of length 4 will correspond.

In the considered context of adaptation of the DMRS pattern, before the method according to any of embodiments 1 to 3, as disclosed above in the present subsection of the specification, is performed, respective ‘pruning’ of said general table should be performed so that the encoding according to those embodiments is performed with respect to acting DMRS ports.

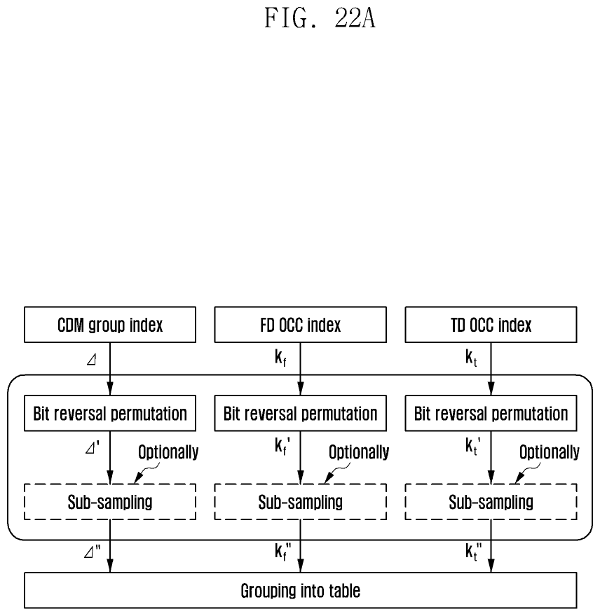

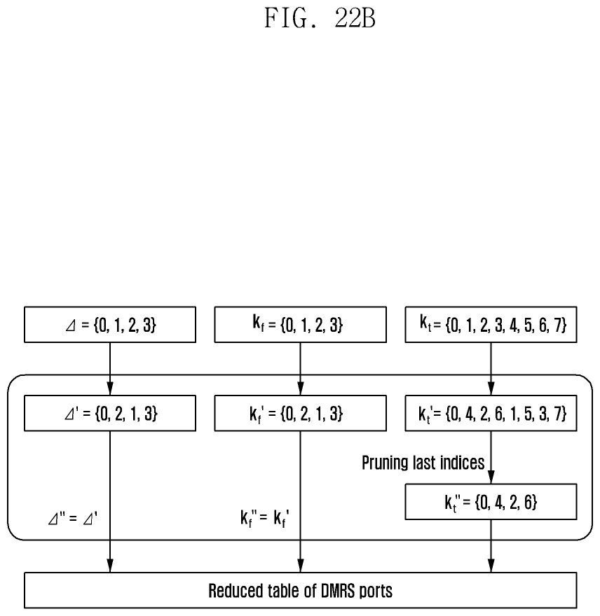

FIG. 22A shows the general approach of preprocessing a DMRS port table for the case of exclusion of part of DMRS ports from usage in view of the abovementioned DMRS pattern adaptation according to an embodiment of the disclosure.

Referring to FIG. 22A, bit reversal permutation is performed with respect to each of the combination of CDM group indices Δ, the combination of FD-OCC indices, and the combination of TD-OCC indices {kₜ} corresponding to the basic, non-adapted DMRS pattern used in the TRP. For instance, for the DMRS pattern according to the disclosure, as illustrated in FIG. 7, Δ={0,1,2,3}, k_{f}={0,1,2,3}, kₜ={0,1,2,3}(respectively, N=64 in FIG. 22A). Briefly speaking, as a result of the bit reversal permutation, every index in each of said combinations is represented in a digital form; then, inversion of the order of bits is performed with respect to this binary representation (i.e., the first bit becomes the last one, the second bit becomes the penultimate one, and the like); thereafter the reversal bit representation is converted back into a numerical representation. As a result, the respective converted combinations of indices are obtained which are denoted in FIG. 22A as {Δ′}, {k_{f}′}, {kₜ′}, respectively.

The respective exclusion is performed specifically with respect to one or more of said converted combinations of indices. The exclusion with respect to each of {Δ′}, {k_{f}′}, {kₜ′} is denoted in FIG. 21A as optional, thereby implying that it is not mandatory for all of said combinations to be subjected to sub-sampling—as follows from the respective disclosure according to subsection I of the specification, the sub-sampling may be performed with respect to a particular one of these combinations, or with respect to two of them, or with respect to all of them. As a result of such sub-sampling, the respective pruned combinations of indices are obtained which are denoted in FIG. 22A as {Δ″}, {k_{f}″}, {kₜ″}, respectively.

Finally, the adapted, reduced table, where DMRS port indices are listed according to the pruned combinations of indices {Δ″}, {k_{f}″}, {kₜ″}, is built from the general DMRS port table.

The general approach disclosed above with reference to FIG. 22A, is illustrated in a specific example of FIG. 22B. This example substantially corresponds to adapting the DMRS pattern illustrated in FIG. 8 according to the approach disclosed with reference to FIG. 12c in subsection I of the specification.

FIG. 22B is an example of implementation of the general approach of FIG. 22A according to an embodiment of the disclosure.

Referring to FIG. 22B, the pruning is performed only with respect to DFT TD-OCCs by dropping away the last four indices in the converted combination thereof, which corresponds to the left branch in FIG. 12Cc. As a result, the reduced DMRS port table is obtained where the entries for DMRS port indices with the excluded DFT TD-OCCs are lacking.

In should be noted herein that, from the mathematical point of view, the pruning based on bit reversal permutation, as described with reference to FIGS. 22A and 22B, is equivalent to the embodiment of adaptation according to the disclosure disclosed in subsection I of the specification with reference to FIGS. 12A to 12D, 13A, 13B, and 14.

As reported above, in the considered case the methods according to embodiments 1 to 3 will be performed based on the reduced tables obtained according to the approach disclosed above with reference to FIGS. 22A and 22B. The illustration thereof may be the DMRS port group tree of FIG. 17 as corresponding to exclusion of 48 DMRS ports from their total number 64, and the tree-like hierarchy of DMRS port groups according to FIGS. 16A and 16B corresponds to this case. As seen from these figures, 7 bits are required for the code representation of a tree node according to FIGS. 16A and 16B, whereas 5 bits are required for the code representation of a tree node according to FIG. 17. That is, additional reduction of DCI bit overhead may be provided due to applying the approach according to FIGS. 22A and 22B.

Though the DMRS patterns disclosed with reference to FIGS. 7 and 8 have been used as examples in the embodiments discussed in the present subsection of the specification, it should be emphasized that the approach to indicating DMRS ports for UEs, as provided herein, equally applies to other advanced DMRS patterns which are planned to be used in next generation wireless communication systems.

### III. Allocating Resources in the Time Domain

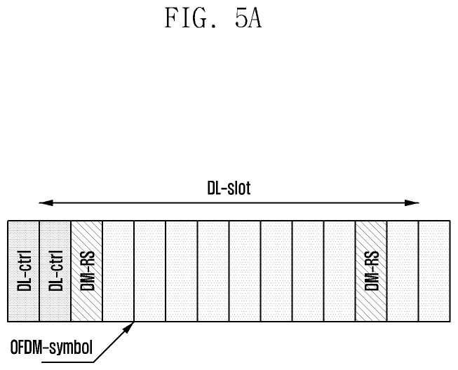

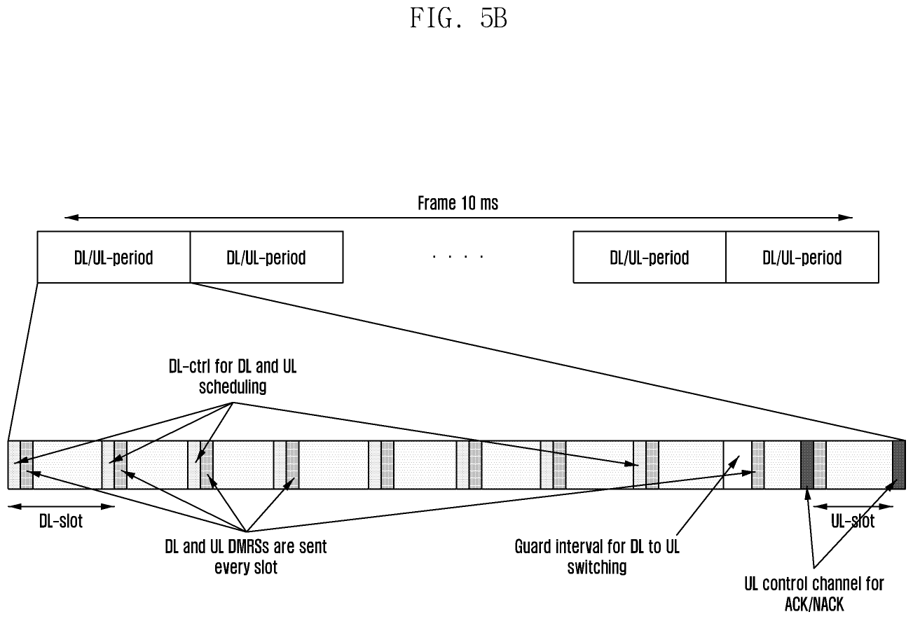

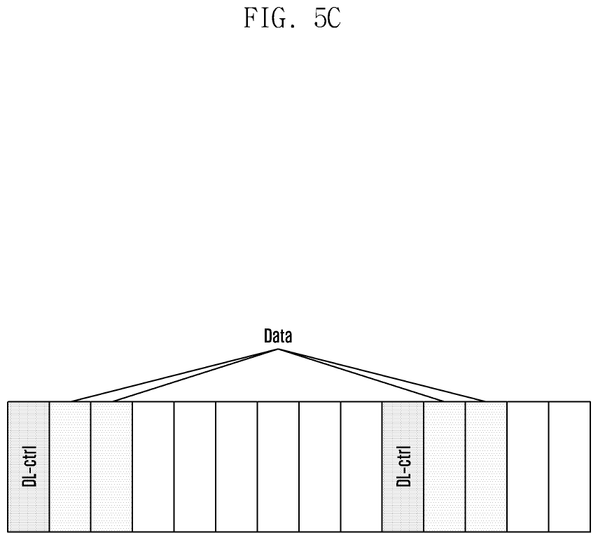

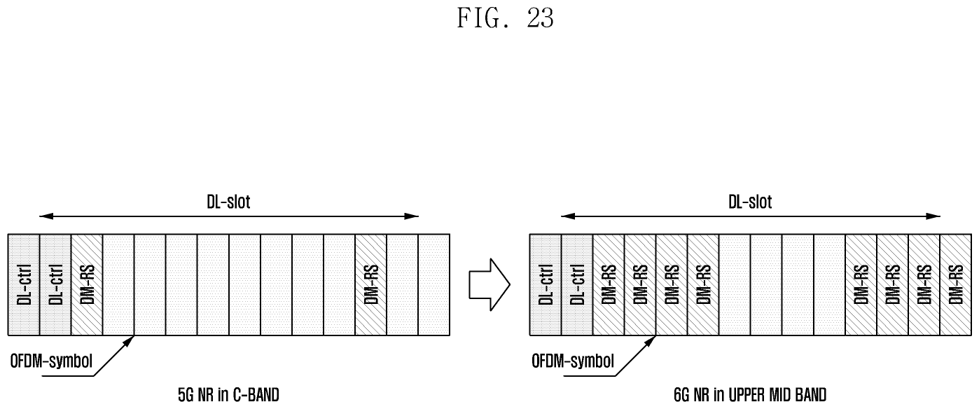

In view of the aforesaid when describing the background art, increased capacity of the new DMRS pattern for next generation (including 6G) wireless communication systems causes such a pattern to occupy a greater number of OFDM-symbols in the time domain. If allocation of time domain resources according to 5G NR is used in this case, for example, according to Type A described with reference to FIGS. 5A and 5B, then the presence of the more capacious DMRS pattern along with the control channel in every slot will lead to undesired growth of overhead. This aspect is pictorially illustrated in FIG. 23, where the DMRS pattern according to the disclosure described with reference to FIG. 7 is implied, as an example, as said new DMRS pattern, and, as seen from the right part of FIG. 23, only 4 OFDM-symbols remain in the slot for 6G PDSCH transmission.

FIG. 23 is an illustration of an attempt to use the 5G NR approach to allocating time resource in a next generation wireless communication system according to an embodiment of the disclosure.

, in 5G NR Type A, allocation of at least one OFDM-symbol for a DMRS signal(s) in every slot is typically required. Therefore, the DMRS signal will be transmitted to a UE with every slot, even if no changes in distribution of DMRS ports have taken place; moreover, at least one symbol is occupied by the control channel in every slot.

Therefore, improved techniques of allocating time domain resources for broadband data transmission, which would enable to avoid the abovementioned negative effects, are required in the considered context.

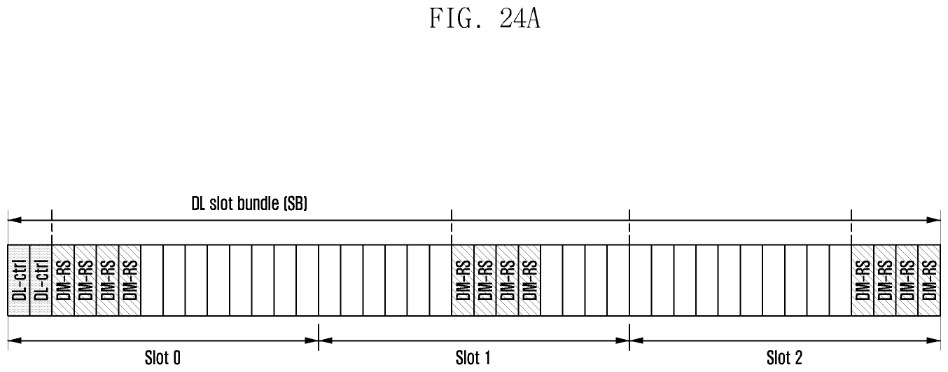

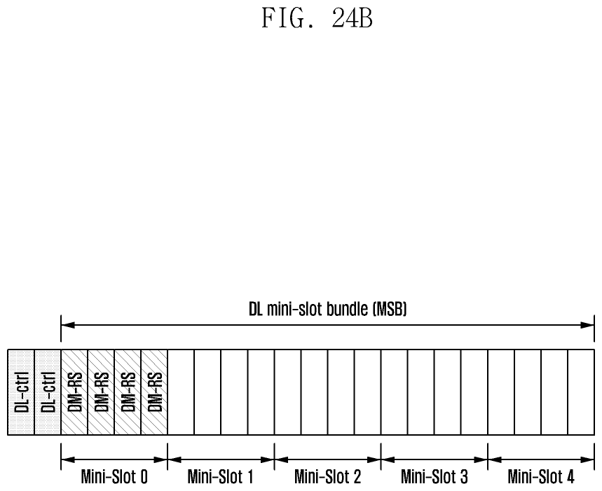

In the application, the aggregated approach to allocating resources in the time domain is provided, both on the slot level and the mini-slot level, which is described in detail below with reference to FIGS. 24A, 24B, 25A, 25B, 26A, 26B, 27, 28A, and 28B.

As in the case of 5G NR, from the macro view, a frame of length 10 ms is divided into a plurality of the same DL/UL-periods, wherein length of a DL/UL-period is configurable in a base station. The base station may signal the set DL/UL-period length to UEs served thereby by using the abovementioned DCI (L1) signaling, MAC (L2) signaling, RRC (L3) signaling, or even some combination thereof. Every DL/UL-period is split into slots, where every slot may consist of 14 or 12 (if the extended cyclic prefix is used in the slot) OFDM-symbols. Each DL/UL-period comprises N_{symb}^{UL-DL} OFDM-symbols in total.

Typically, a part of slots of a DL/UL-period is allocated for downlink (DL) transmission (a DL-part), while another part of slots of the DL/UL-period is allocated for uplink (UL) transmission (a UL-part). The DL-part and the UL-part are separated from each other by a guard interval (GI) to provide time for switching between the DL transmission and the UL transmission. Part of a slot of the DL-part or of the UL-part is usually allotted for the guard interval. It should be noticed that distribution of slots between the DL- and UL-parts is configurable in the base station—for instance, all N_{symb}^{UL-DL} OFDM-symbols of the DL/UL-period may be allocated only for the DL-part.

Flexible aggregation of slots is provided in the application, so that a larger unit is utilized for allocating/scheduling resources in the time domain than a single slot (Type A in 5G NG) or a single mini-slot (Type B in 5G NG). That is, it is assumed that allocation of resources in the time domain for transmitting data may be performed in such aggregated units.

embodiments of the aggregation for the DL-part of a DL/UL-period of a frame will be described first with reference to FIGS. 24A and 24B.

FIG. 24A shows, along the time axis, OFDM-symbols which constitute three slots of the DL-part of the DL/UL-period according to an embodiment of the disclosure. These slots are aggregated into a single bundle of slots which forms the new unit of scheduling/allocating time domain resources. Unlike the respective 5G NR Type A (see FIG. 5A), adjacent OFDM-symbols allocated for transmission of the downlink control channel (DL-ctrl) are allocated per entire slot bundle rather than per every slot, as in the case of 5G NR Type A.

Adjacent OFDM-symbols are also allocated for transmission of a DMRS pattern; such adjacent symbols will be referred to hereinafter as a DMRS-subbundle. DMRS signals for a required number of MIMO layers of the PDSCH to be transmitted are multiplexed in the DMRS pattern. The DMRS pattern according to the disclosure, as described above with reference to FIG. 7, is assumed herein as said DMRS pattern, for purposes. Every occasion of a DMRS-subbundle in the DL/UL-period is indexed by index l̅=0, 1, 2, . . . .

It should be emphasized that the allocation of DMRS-subbundles, as shown FIG. 24A, is illustrative, and other allocations thereof may be used. Then, DMRS patterns of smaller and greater capacity have been considered above which respectively greater and smaller density in the time domain and/or frequency domain than the pattern of FIG. 7 supposed herein as an illustration; i.e., the DMRS-subbundle size of 4 OFDM-symbols, as shown in FIG. 24A, does not impose any limitations either. The aspects of allotting DMRS-subbundles will be discussed in more detail below.

The remaining OFDM-symbols in the slot bundle may be allocated for transmission of the PDSCH. Though FIG. 24A shows allocation of all the remaining symbols, it should be appreciated that a greater or smaller number thereof may be allocated for the PDSCH transmission. Then, every slot in FIG. 24A is shown comprising 14 OFDM-symbols; at the same time, as recited above, a slot may comprise 12 OFDM-symbols. The indicated specific aspects do not impose any limitations onto the discussed technical solution.

FIG. 24B shows, along the same time axis, OFDM-symbols which constitute four mini-slots of the DL-part of the DL/UL-period, each mini-slot comprising 4 OFDM-symbols according to an embodiment of the disclosure. These mini-slots are aggregated into a single bundle of mini-slots which also forms a new unit of scheduling/allocating time domain resources. Unlike the respective 5G NR Type B (see FIG. 5C), adjacent OFDM-symbols of the downlink control channel (DL-ctrl), like in the case of FIG. 24A, are allotted per entire mini-slot bundle rather than per every mini-slot, as in the case of 5G NR Type B. The attention should be drawn to the fact that in the considered example adjacent OFDM-symbols allocated for transmission of the DL-ctrl precede the mini-slot bundle, being not included thereby. This does not impose any limitation, and the mini-slot bundle may be arranged including the DL-ctrl OFDM-symbols.

Similarly to the discussion according to FIG. 24A, a DMRS-subbundle may be also allotted in the mini-slot bundle for transmission of a DMRS pattern. In this case, solely for the sake of illustration, the DMRS-subbundle is shown occupying the entire mini-slot within the mini-slot bundle that follows after the DL-ctrl symbols.

The other OFDM-symbols in the mini-slot bundle may be allocated for transmission of the PDSCH. Though FIG. 24B shows allocation of all the other symbols, it should be appreciated that a greater or smaller number thereof may be allocated for the PDSCH transmission.

Then, every mini-slot in FIG. 24B is shown comprising 4 OFDM-symbols; at the same time, as outlined above, a mini-slot may be also comprised of 1 or 2 or 7 OFDM-symbols, and the DMRS-subbundle itself may have a different size, as recited with respect to FIG. 24A, and may not be aligned with boundaries of a mini-slot. The indicated specific aspects do not impose any limitations onto the discussed technical solution.

The mini-slot length is in general set in a TRP and signaled from the TRP to UEs through a control message. For example, an RRC message or a DCI message may be used to indicate the mini-slot length. A combination of RRC and DCI messages may be also used, when the RRC message specifies a subset of mini-slot length values: for example, the subset {2, 7} is specified from the entire set {2, 4, 7, 14}, while the DCI message indicates one specific value from said subset (i.e., 1 bit in the DCI selects either 2 or 7) which relates to the current PDSCH signal transmission.

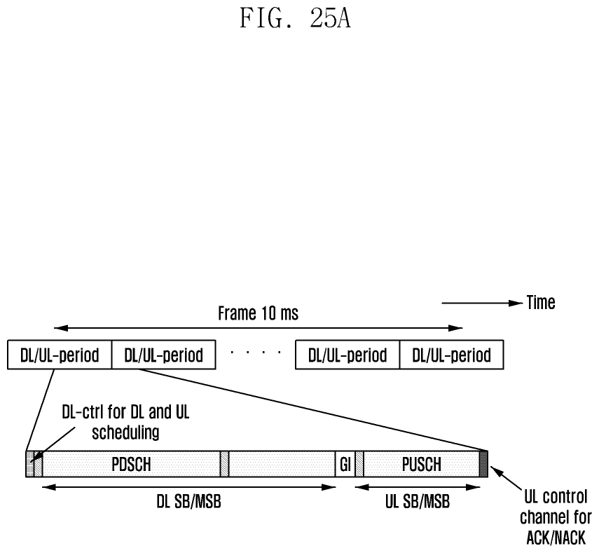

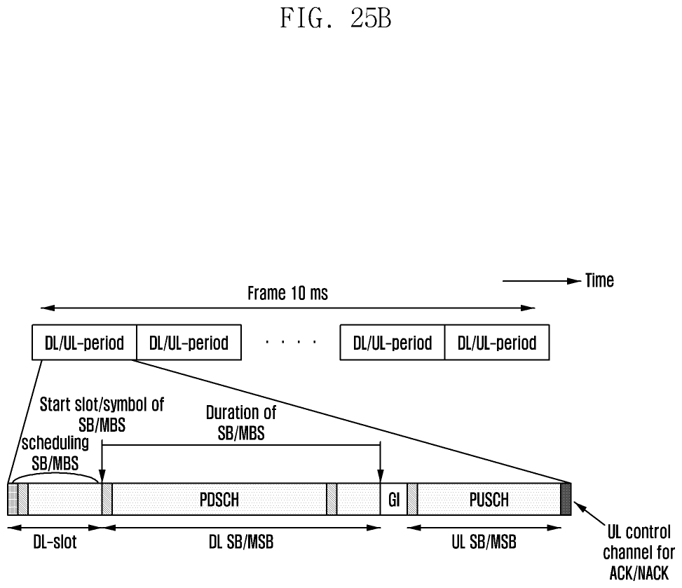

FIGS. 25A and 25B show macro views of the aggregation according to various embodiments of the disclosure.

FIG. 25A shows the case when a bundle of slots or mini-slots occupies the entire DL-part, and FIG. 25B illustrates the case when a bundle of slots or mini-slots is preceded by a slot. It should be emphasized for the embodiment of FIG. 25B that the abovementioned OFDM-symbols for the DL-ctrl are included by the preceding slot, at the same time, said DL-ctrl contains control information for scheduling the bundle of slots/mini-slots. In other words, the presence of the DL-ctrl OFDM-symbols in the slot bundle, as depicted in FIG. 24A, is not mandatory according to the application. The embodiment of FIG. 25B may be considered as corresponding to the combination of the known approach (5G NR Type A) and the approach provided in the application. It should be appreciated that the bundle of slots/mini-slots may be preceded by more than one slot; moreover, an embodiment is possible when the bundle of slots/mini-slots will precede one or more slots.

It should be explained that, in accordance with the approach proposed in the application, the DL-ctrl may reside, in general, in any place of the DL/UL-period according to the configuration of decoding the control channel. The principal requirement is that, for a specific UE, transmission of the DL-ctrl takes place prior to the beginning of the bundle of slots/mini-slots, so that the UE is able to receive the control channel and decode the DCI which will contain information about scheduling of the PDSCH (including information about the beginning of transmission of the bundle of slots/mini-slots and duration of said bundle).

Reduced overhead is clearly seen from the illustrations according to FIGS. 25A and 25B—in particular, reservation of an OFDM-symbol(s) for the DL-ctrl for every slot/mini-slot is avoided; furthermore, the possibility of using less frequent DMRS occasions within the DL/UL-period, without reduction of the channel estimation quality, is provided.

In accordance with a preferable embodiment, DMRS-subbundles are allocated within the DL-part with a preset period T_{DMRS}.

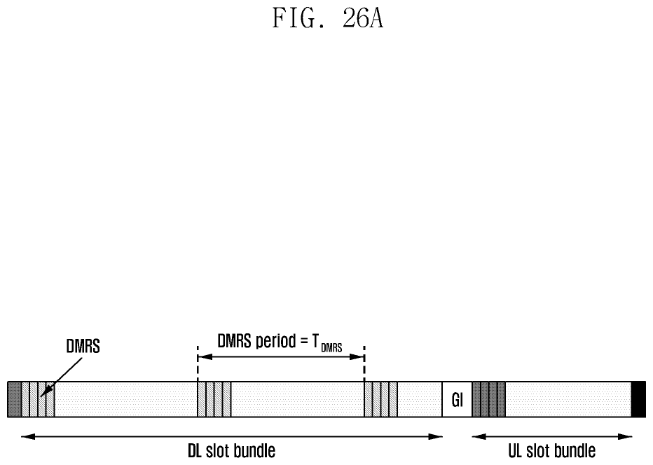

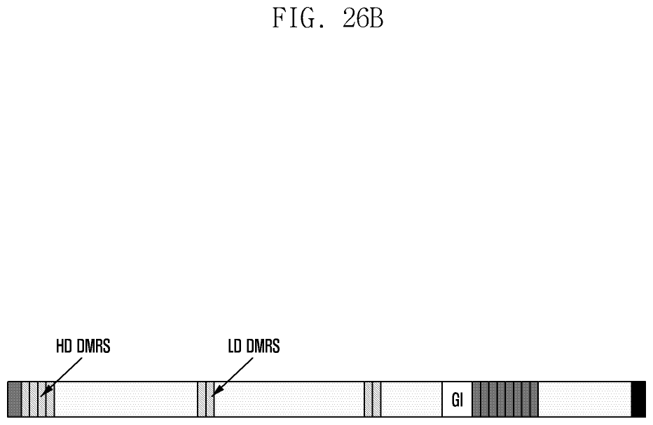

FIGS. 26A and 26B are illustrations of periodic allocation of DMRS sub-bundles when allotting time domain resources according to various embodiments of the disclosure.

FIG. 26A shows periodic consecution of DMRS-subbundles allocated for transmission of the DMRS pattern with the same density within the bundle of slots/mini-slots. The illustration of FIG. 24A refers to this case.

It should be emphasized that the periodic configuration of DMRS-subbundles should not be mandatorily within boundaries of the bundle of slots/mini-slots, as shown in FIGS. 24A and 26A—for instance, in the embodiment of FIG. 25B this DMRS periodicity may not be anchored to the boundaries of the bundle of slots/mini-slots. In other words, this does not impose a limitation onto the technical solution disclosed herein.

FIG. 26B shows another preferable embodiment, where DMRS-subbundles are allocated within the DL-part also with a preset period T_{DMRS}, but in this case the amount of resources allocated for transmission of the DMRS pattern in the first DMRS-subbundle is greater than the amount of resources allocated for transmission of the DMRS pattern in each of the subsequent DMRS-subbundles. In particular, as seen from FIG. 26B, the number of OFDM-symbols of the subsequent DMRS-subbundle is less than the number of OFDM-symbols of the first DMRS-subbundle, unlike FIG. 26a, and in the embodiment according to FIG. 26B the first DMRS-subbundle may be referred to as high density (HD) DMRS-subbundle, while every subsequent subbundle can may referred to as low density (LD) DMRS-subbundle. In this case, additional reduction of overhead obviously takes place.

For example, the DMRS pattern corresponding to the one illustrated in FIG. 10 or FIG. 2A may be transmitted with repetition in the HD DMRS-subbundle, thereby occupying 4 OFDM-symbols in the time domain, and without repetition in every subsequent LD DMRS-subbundle, thereby each occupying 2 OFDM-symbols. This example may be considered to be nominally corresponding to the illustration of FIG. 26B.

The situation illustrated by FIG. 26B may take place in the following case. When establishing a connection between a TRP and a UE, more reliable channel estimation may be required at the UE side, and to this end greater DMRS density may be required in the time and frequency domain, as a consequence, an HD DMRS-subbundle will be allocated. Thereafter, after the connection has been established, channel estimation will be performed in the UE substantially on the level of adjustment, based on the available data/measurements acquired earlier. In such a case, LD DMRS-subbundles will be used for the DMRS transmission.

It should be emphasized that the considered periodic approach to DMRS allocation is preferable but not limiting, and DMRS-subbundles may be allocated in a non-periodic way, which follows, in particular, from the illustration of FIGS. 25A and 25B.

As noted above, scheduling of time domain resources to transmit data is performed by a scheduler of a base station (transmission-reception point (TRP)), and UEs are informed about the resources reserved by the scheduler via the downlink control channel transmitted from the TRP. In accordance with the application, a bundle of slots or mini-slots may be used as a unit of scheduling/allocating time domain resources for transmission, unlike a single slot or mini-slot according to 5G NR. The aggregation configuration according to the application is set by the base station (transmission-reception point (TRP)), and information about said configuration is signaled to UEs in the downlink control channel (DL-ctrl). According to the preferred embodiment, said information is at least partially transmitted in the DCI message carried in the PDCCH. The DCI signals, in particular, an indication of the beginning of the bundle of slots/mini-slots in the DL/UL-period, the slot/mini-slot bundle length, an indication of the number of slots/mini-slots allocated within the bundle of slots/mini-slots for the PDSCH, the DMRS period which in general may be different for the DL-part and the UL-part. It should be noted that the DCI may further signal other control information which have been mentioned in this and preceding sections of the specification.

The start OFDM-symbol (lₛₜₐᵣₜ^{PDSCH}) of the bundle of slots/mini-slots within the DL/UL-period may be indicated in the DCI as the beginning of said bundle; for the slot bundle, its start slot may be indicated as said beginning.

The length of the bundle of slots/mini-slots is set in the TRP as a function of a scheduler decision which may depend on a size of data transmitted to a user, the necessity to transmit data to another user, a transmitted traffic type, a channel state (modulation, coding rate, a number of MIMO layers), transmission of other scheduled signals, and the like.

The period T_{DMRS} of the bundle of slots/mini-slots may be set in the TRP depending on a speed at which a transmission channel changes with time. For instance, fast change of the channel may take place owing to, in particular, travelling of the UE, and, owing to said change, a decision may be taken in the TRP to adjust T_{DMRS} downwards so that DMRS signals are sent more frequently for the respective tuning.

Then, channel coding is typically performed with respect to data to be transmitted in the PDSCH. Channel coding is block coding, and encoded data is represented as a result as code blocks of certain length. LDPC coding may be a possible embodiment of channel coding. The code blocks are then respectively mapped to time-frequency resources for transmission in the PDSCH. Each code block is mapped to time-frequency resources as a whole.

Moreover, if the existing procedure of determining the number of code blocks for data transmission, as disclosed in TS 38.212 5G NR, is directly applied when mapping code blocks to time-frequency resources, then said procedure should be applied to the entire bundle of slots/mini-slots according to the application (e.g., the entire DL-part of the DL/UL-period), and, as a consequence, alignment of temporal boundaries of an integer number of code blocks will be ensured only by the end of such a bundle of slots/mini-slots. That is, if the existing approach is directly used, then alignment of temporal boundaries of an integer number of code blocks with a slot or mini-slot boundary will not be ensured, in general. As a consequence, processing of received data may not start at the receiver side until the entire aggregated bundle of slots/mini-slots is received. In other words, a downtime occurs at the receiver side, said downtime being associated with the necessity of buffering the received code blocks while waiting for the end of reception of the aggregated bundle, so that the processing of said code blocks could begin.

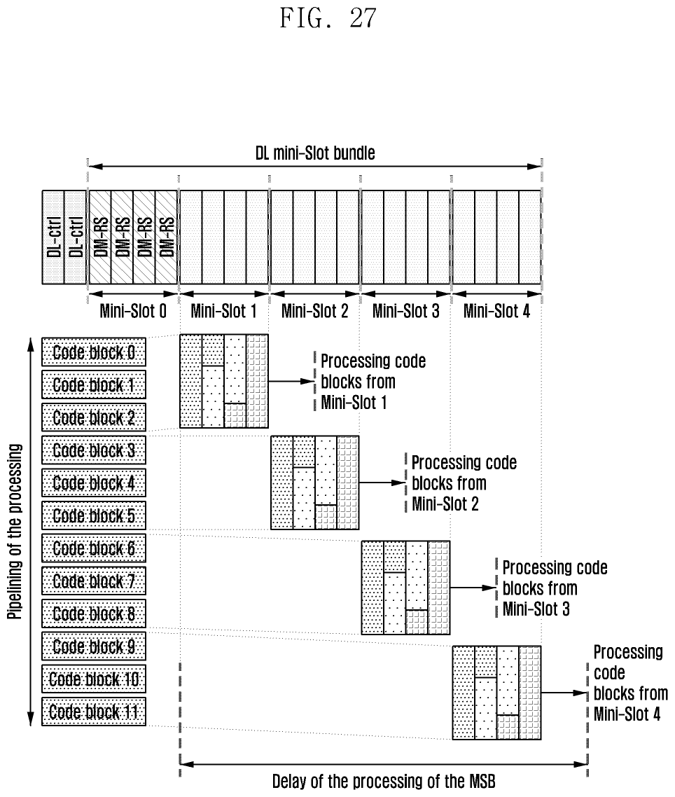

The approach of flexible aggregation of time domain resources, as provided in the application, enables to resolve this problem and improve efficiency of pipelining of the code block processing at the receiver side, which is illustrated in FIG. 27.

In accordance with a preferable embodiment, the number and length of code blocks are selected according to a mini-slot length in such a way that, when allocating time-frequency resources for every combination of said number of code blocks, boundaries of this combination in the time domain are aligned specifically with mini-slot boundaries in a mini-slot bundle. More particularly, the number and length of code blocks are selected according to the number of available REs in a mini-slot, modulation being used, and channel coding rate. Moreover, in the considered embodiment, usage of said existing procedure of determining the number of code blocks, as described in TS 38.212 5G NR, is substantially performed specifically with respect to each group of OFDM-symbols which form a mini-slot, individually.

FIG. 27 shows alignment of sets of three code blocks with boundaries of mini-slots in a mini-slot bundle according to an embodiment of the disclosure. As a consequence, data processing in the receiver may start almost immediately upon reception of the first mini-slot comprising three (i.e., integer number) of code blocks; then, upon reception of the second mini-slot, the processing of the next three code blocks will be performed; etc. It should be obvious that, in the considered embodiment, downtimes associated with the processing of the received data, are significantly reduced. Attention should be also drawn to high flexibility of the considered embodiment, since, besides the length and number of code blocks, the mini-slot duration is itself flexibly configurable.

It should be emphasized that, though the embodiment described above is preferable for the mini-slot-level aggregation, it is nevertheless equally applicable to slot-level aggregation. In view of the aforesaid, it should be obvious for the slot-level implementation that a greater delay will take place than in the illustrated case of mini-slots.

The techniques of aggregating time domain resources according to the application, as described with reference to FIGS. 24A, 24B, 25A, 25B, 26A, 26B, and 27 with respect to the DL-part of the DL/UL-period of the frame, apply to its UL-part as well. In this case the specificity is in that the TRP scheduler decision is single with respect to both the DL-part and the UL-part, and information regarding allocation of time domain resources for the UL-part is also signaled in the downlink control channel (DL-ctrl), as discussed above. For instance, the beginning and duration of transmission of an UL bundle of slots/mini-slots is selected in the TRP and signaled to the UE by the control information in the downlink control channel; more particularly, said selection is performed by the TRP scheduler, and said signaling is performed through the DCI in the PDCCH.

Therefore, an uplink control channel, which is the PUCCH in the considered case, will in general have different functionality as compared to the downlink control channel. In particular, in the UL-part, there is no mandatory requirement for the control channel to precede the DMRS and PUSCH; furthermore, the uplink control channel may be absent at all in the UL-part.

For instance, in FIGS. 25A and 25B, exclusively for the sake of illustration, the control channel is shown as located in the tail of the bundle of slots/mini-slots and containing acknowledgement (ACK/NACK) information. Nevertheless, in the UL-part, OFDM-symbols allocated for the uplink control channel may precede OFDM-symbols allocated for the DMRS and PUSCH. It should be emphasized that, in general, the bundle of slots/mini-slots according to the application may be substantially in any place of the UL-part.

Since the PUCCH is not directly associated with resource scheduling, then options are possible when transmission of the PUCCH will not relate anyhow to a bundle(s) of slots/mini-slots (neither to slots or mini-slots at all)—for example, said channel may be used to transmit a Scheduling Request or Channel State Information (CSI), —or when transmission of the PUCCH will relate to preceding slots, mini-slots, or a bundle(s) of slots/mini-slots.

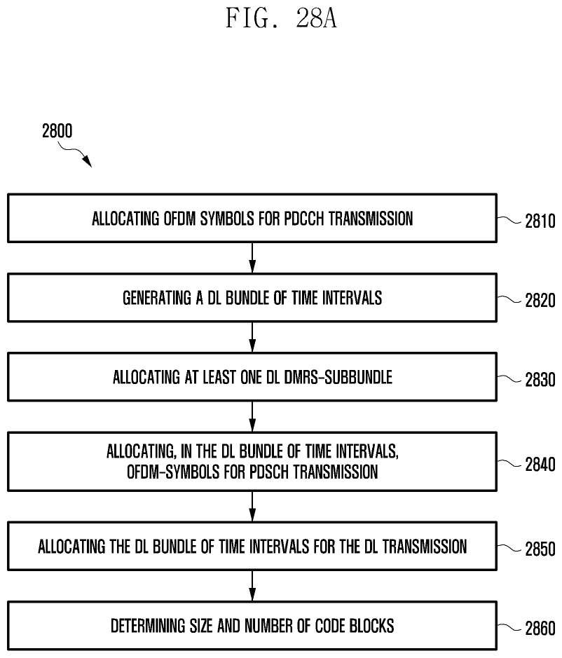

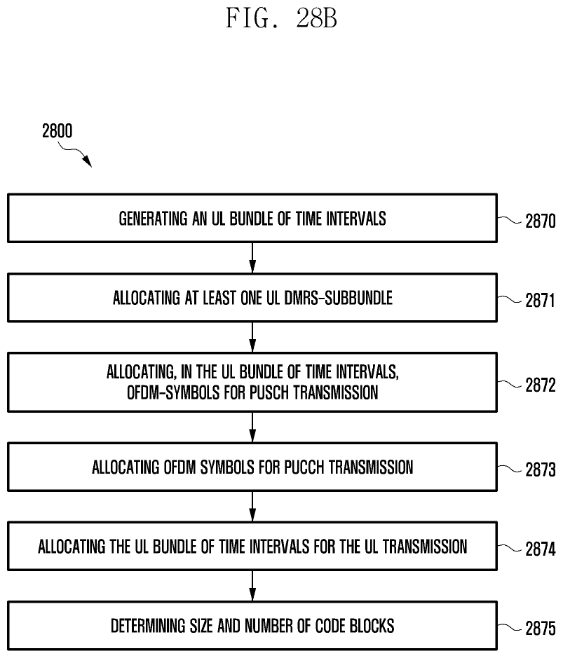

Then, an embodiment of the method 2800 of allocating resources in the time domain according to the application is described hereinafter with reference to FIGS. 28A and 28B. As an illustration, the method 2800 is performed in a base station (e.g., the TRP 602 in FIG. 6) which supports simultaneous transmission of a plurality of spatial MIMO layers of the PDSCH.

FIGS. 28A and 28B are a flowchart of the method of allocating resources in the time domain according to various embodiments of the disclosure.

Operations 2810-2860 of the method 2800, which are performed with respect to a DL-part of an DL/UL-period of a frame, are considered with reference to FIG. 28A.

In operation 2810, a preset number of adjacent OFDM-symbols are allocated for transmission of a downlink control channel which is preferably the PDCCH.

In operation 2820, a DL bundle of time intervals is generated, the bundle comprising an integer number of adjacent time intervals, wherein each time interval includes a preset number of OFDM-symbols. Moreover, the PDCCH, which is to be transmitted in the OFDM-symbols of the DL-part that have been allocated thereto, relates to the entire bundle of time intervals. In accordance with the above disclosure, the time interval may be a slot which may comprise 12 or 14 OFDM-symbols, or a mini-slot which may comprise 1, 2, 4, or 7 OFDM-symbols.

In operation 2830, at least one DL DMRS-subbundle is allocated to transmit DMRS signals for a required number of MIMO layers of the PDSCH.

In operation 2840, OFDM-symbols for transmission of the PDSCH are allocated in the DL bundle of time intervals.

The possible embodiments of mutual arrangement of OFDM-symbols for the PDCCH, the DL DMRS-subbundle(s), and the bundle of slots/mini-slots in the DL-part are described above, in particular, with reference to FIGS. 24A, 24B, 25A, 25B, 26A, and 26B.

In operation 2850, the DL bundle of time intervals is allocated for the scheduled DL transmission.

As reported above multiple times, the control information should be transmitted in the PDCCH, more specifically—in the DCI message. Besides the control data which have been outlined above, in the considered case the control information may include an indication of the beginning of the DL bundle of time intervals and a duration of the DL bundle of time intervals. If, according to the preferred embodiment (see FIGS. 26A and 26B), the DMRS-subbundles are arranged with a period T_{DMRS}, then T_{DMRS} is also included into the control information.

In operation 2860, for data to be transmitted in the OFDM-symbols allocated for the PDSCH in the DL bundle of time intervals, a size and a number of code blocks are determined to perform channel coding (preferably, LDPC), and code blocks representing the encoded data are obtained. The number and the length of the code blocks are selected in such a way that, when allocating time-frequency resources for every combination of said number of code blocks, boundaries of said combination in the time domain are aligned with boundaries of a time interval in the bundle of time intervals (see FIG. 27).

Operations 2870-2875 of the method 2800, which are performed with respect to an UL-part of the DL/UL-period of the frame, are considered with reference to FIG. 28B.

In operation 2870, an UL bundle of time intervals which comprises an integer number of time intervals is generated.

In operation 2871, at least one UL DMRS-subbundle is allocated to transmit a DMRS pattern wherein DMRS signals for a required number of MIMO layers of the PUSCH are multiplexed.

In operation 2872, OFDM-symbols for transmission of the PUSCH are allocated.

In operation 2873, a preset number of adjacent OFDM-symbols are allocated for transmission of the PUCCH.

The possible embodiments of mutual arrangement of OFDM-symbols for the PUCCH, the UL DMRS-subbundle(s), and the bundle of slots/mini-slots in the UL-part are described above.

In operation 2874, the UL bundle of time intervals is allocated for the UL transmission.

In operation 2875, similarly to operation 2860, channel coding, along with respectively selecting a number and a length of code blocks, is performed with respect to data to be transmitted in the OFDM-symbols allocated for the PUSCH in the UL bundle of time intervals.

It should be emphasized that, though in the embodiments considered in the present subsection of the specification the DMRS pattern disclosed with reference to FIG. 7 and other DMRS patterns according to the disclosure have been used for purposes, it should be appreciated that the approach to time resource allocation, as proposed herein, equally applies to other advanced DMRS patterns which are planned for being used in next generation wireless communication systems.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, by the UE from a base station, at least one configuration information associated with a demodulation reference signal (DMRS);
identifying, by the UE, at least one of a code division multiplexing (CDM) group, a frequency domain (FD) orthogonal cover code (OCC), and a time domain (TD) OCC for the DMRS based on the at least one configuration information; and
receiving, by the UE from the base station, the DMRS based on the at least one of the CDM group, the FD OCC, and the TD OCC,
wherein a number of CDM groups is 4,
wherein the FD OCC includes at least one of (+1,+1,+1,+1), (+1,−j,+1,+j), (+1,−1,+1,−1), and (+1,+j,−1,−1), and
wherein the TD OCC includes at least one of (+1,+1,+1,+1), (+1,−j,+1,+j), (+1,−1,+1,−1), and (+1,+j,−1,−1).

2. The method of claim 1,
wherein a plurality of available FD OCC indexes are identified based on a modulo operation using a number of FD OCCs to be used and a total number of the FD OCCs, and
wherein a plurality of available TD OCC indexes are identified based on a modulo operation using a number of TD OCCs to be used and a total number of the TD OCCs.

3. The method of claim 1, wherein a spacing between resource elements (REs) for one CDM group of the DMRS is same in a frequency domain.

4. The method of claim 1,
wherein sequences of the DMRS of a CDM group are based on an initialization using a plurality of initialization values included in a set,
wherein a plurality of sets is configured, and
wherein the set among the plurality of sets is indicated by control information associated with data corresponding to the DMRS.

5. The method of claim 1, wherein the DMRS is modulated as quadrature phase shift keying (QPSK) symbols.

6. A method performed by a base station in a wireless communication system, the method comprising:
transmitting, by the base station to a user equipment (UE), at least one configuration information associated with a demodulation reference signal (DMRS), wherein the at least one configuration information indicates at least one of a code division multiplexing (CDM) group, a frequency domain (FD) orthogonal cover code (OCC), and a time domain (TD) OCC for the DMRS;
mapping, by the base station, the DMRS to resource elements (REs) based on the at least one of the CDM group, the FD OCC, and the TD OCC; and
transmitting, by the base station to the UE, the DMRS,
wherein a number of CDM groups is 4,
wherein the FD OCC includes at least one of (+1,+1,+1,+1), (+1,−j,+1,+j), (+1,−1,+1,−1), and (+1,+j,−1,−1), and
wherein the TD OCC includes at least one of (+1,+1,+1,+1), (+1,−j,+1,+j), (+1,−1,+1,−1), and (+1,+j,−1,−1).

7. The method of claim 6,
wherein a plurality of available FD OCC indexes are based on a modulo operation using a number of FD OCCs to be used and a total number of the FD OCCs, and
wherein a plurality of available TD OCC indexes are identified based on a modulo operation using a number of TD OCCs to be used and a total number of the TD OCCs.

8. The method of claim 6, wherein a spacing between REs for one CDM group of the DMRS is same in a frequency domain.

9. The method of claim 6,
wherein sequences of the DMRS of a CDM group are obtained based on an initialization using a plurality of initialization values included in a set,
wherein a plurality of sets is configured, and
wherein the set among the plurality of sets is indicated by control information associated with data corresponding to the DMRS.

10. The method of claim 6, wherein the DMRS is modulated as quadrature phase shift keying (QPSK) symbols.

11. A user equipment (UE) in a wireless communication system, the UE comprising:
transceivers;
memory storing one or more computer programs; and
one or more processors communicatively coupled to the transceivers and the memory,
wherein the one or more computer programs include computer-executable instructions that, when executed collectively by the one or more processors, cause the UE to:
receive, from a base station, at least one configuration information associated with a demodulation reference signal (DMRS),
identify at least one of a code division multiplexing (CDM) group, a frequency domain (FD) orthogonal cover code (OCC), and a time domain (TD) OCC for the DMRS based on the at least one configuration information, and
receive, from the base station, the DMRS based on the at least one of the CDM group, the FD OCC, and the TD OCC,
wherein a number of CDM groups is 4,
wherein the FD OCC includes at least one of (+1,+1,+1,+1), (+1,−j,+1,+j), (+1,−1,+1,−1), and (+1,+j,−1,−1), and
wherein the TD OCC includes at least one of (+1,+1,+1,+1), (+1,−j,+1,+j), (+1,−1,+1,−1), and (+1,+j,−1,−1).

12. The UE of claim 11,
wherein a plurality of available FD OCC indexes are identified based on a modulo operation using a number of FD OCCs to be used and a total number of the FD OCCs, and
wherein a plurality of available TD OCC indexes are identified based on a modulo operation using a number of TD OCCs to be used and a total number of the TD OCCs.

13. The UE of claim 11, wherein a spacing between resource elements (REs) for one CDM group of the DMRS is same in a frequency domain.

14. The UE of claim 11,
wherein sequences of the DMRS of a CDM group are based on an initialization using a plurality of initialization values included in a set,
wherein a plurality of sets is configured, and
wherein the set among the plurality of sets is indicated by control information associated with data corresponding to the DMRS.

15. The UE of claim 11, wherein the DMRS is modulated as quadrature phase shift keying (QPSK) symbols.

16. A base station in a wireless communication system, the base station comprising:
transceivers;
memory storing one or more computer programs; and
one or more processors communicatively coupled to the transceivers and the memory,
wherein the one or more computer programs include computer-executable instructions that, when executed collectively by the one or more processors, cause the base station to:
transmit, to a user equipment (UE), at least one configuration information associated with a demodulation reference signal (DMRS), wherein the at least one configuration information indicates at least one of a code division multiplexing (CDM) group, a frequency domain (FD) orthogonal cover code (OCC), and a time domain (TD) OCC for the DMRS,
map the DMRS to resource elements (REs) based on the at least one of the CDM group, the FD OCC, and the TD OCC, and
transmit, to the UE, the DMRS,
wherein a number of CDM groups is 4,
wherein the FD OCC includes at least one of (+1,+1,+1,+1), (+1,−j,+1,+j), (+1,−1,+1,−1), and (+1,+j,−1,−1), and
wherein the TD OCC includes at least one of (+1,+1,+1,+1), (+1,−j,+1,+j), (+1,−1,+1,−1), and (+1,+j,−1,−1).

17. The base station of claim 16,
wherein a plurality of available FD OCC indexes are based on a modulo operation using a number of FD OCCs to be used and a total number of the FD OCCs, and
wherein a plurality of available TD OCC indexes are identified based on a modulo operation using a number of TD OCCs to be used and a total number of the TD OCCs.

18. The base station of claim 16, wherein a spacing between REs for one CDM group of the DMRS is same in a frequency domain.

19. The base station of claim 16,
wherein sequences of the DMRS of a CDM group are obtained based on an initialization using a plurality of initialization values included in a set,
wherein a plurality of sets is configured, and
wherein the set among the plurality of sets is indicated by control information associated with data corresponding to the DMRS.

20. The base station of claim 16, wherein the DMRS is modulated as quadrature phase shift keying (QPSK) symbols.

21. One or more non-transitory computer-readable storage media storing one or more computer programs including computer-executable instructions that, when executed by one or more processors of a user equipment (UE), cause the UE to perform operations, the operations comprising:
receiving, by the UE from a base station, at least one configuration information associated with a demodulation reference signal (DMRS);
identifying, by the UE, at least one of a code division multiplexing (CDM) group, a frequency domain (FD) orthogonal cover code (OCC), and a time domain (TD) OCC for the DMRS based on the at least one configuration information; and
receiving, by the UE, from the base station, the DMRS based on the at least one of the CDM group, the FD OCC, and the TD OCC,
wherein a number of CDM groups is 4,
wherein the FD OCC includes at least one of (+1,+1,+1,+1), (+1,−j,+1,+j), (+1,−1,+1,−1), and (+1,+j,−1,−1), and
wherein the TD OCC includes at least one of (+1,+1,+1,+1), (+1,−j,+1,+j), (+1,−1,+1,−1), and (+1,+j,−1,−1).

22. The one or more non-transitory computer-readable storage media of claim 21,
wherein a plurality of available FD OCC indexes are identified based on a modulo operation using a number of FD OCCs to be used and a total number of the FD OCCs, and
wherein a plurality of available TD OCC indexes are identified based on a modulo operation using a number of TD OCCs to be used and a total number of the TD OCCs.
